(19) United States
(12) Patent Application Publication
(10) Pub. No.: US 2025/0261038 A1
(43) Pub. Date: Aug. 14, 2025

(54) METHODS AND APPARATUS FOR REPORTING BUFFER STATUS

(71) Applicant: Huawei Technologies Co., Ltd., Shenzhen (CN)

(72) Inventor: Yunsong Yang, San Diego, CA (US)

(21) Appl. No.: 19/197,780

(22) Filed: May 2, 2025

Related U.S. Application Data
(63) Continuation of application No. PCT/US2023/036469, filed on Oct. 31, 2023.
(60) Provisional application No. 63/588,879, filed on Oct. 9, 2023.
(60) Provisional application No. 63/501,302, filed on May 10, 2023.
(60) Provisional application No. 63/422,288, filed on Nov. 3, 2022.

(51) Int. Cl. H04W 28/02

(52) U.S. Cl. CPC H04W 28/0278

(57) ABSTRACT

According to embodiments, a user equipment (UE) sends, to a base station, a status report about data packets stored in a buffer of the UE. The data packets are associated with a logical channel group (LCG). The data packets include a first set of data packets and a second set of data packets. The status report indicates at least a first total size of the first set. The UE receives, from the base station, scheduling information. The UE transmits, to the base station, at least the first set stored in the buffer in accordance with the scheduling information.

### CROSS-REFERENCE TO RELATED APPLICATIONS

This application is a continuation of PCT Application No. PCT/US2023/036469, filed on Oct. 31, 2023 and entitled “Methods and Apparatus for Reporting Buffer Status,” which claims the benefit to U.S. Provisional Patent Application No. 63/422,288, filed on Nov. 3, 2022 and entitled “Methods and Apparatus for a Transmitting Device Reporting Its Transmission Buffer Status,” U.S. Provisional Patent Application No. 63/501,302, filed on May 10, 2023 and entitled “Methods and Apparatus for Reporting Buffer Status,” and U.S. Provisional Patent Application No. 63/588,879, filed on Oct. 9, 2023 and entitled “Methods and Apparatus for Reporting Buffer Status,” applications of which are incorporated herein by reference in their entireties.

### TECHNICAL FIELD

The present disclosure relates generally to wireless communications, and, in particular embodiments, to methods and apparatus for a transmitting device to report transmission buffer status.

### BACKGROUND

In a wireless communication system compliant with the fifth generation (5G) new radio (NR) standards, one or more data radio bearers (DRBs) may be configured for a user equipment (UE) to communicate with a Next Generation (NG) NodeB (gNB) serving the UE, depending on the number of quality of service (QOS) flows of the service(s) being supported. Data transmissions over the uplink (UL) (i.e., from the UE to the gNB) are scheduled by the gNB, based on a variety of information, among which is the buffer status of the UE. This disclosure uses the gNB as an example radio access network (RAN) node, which communicates with the UE in various example embodiments of the embodiment techniques described herein.

In accordance with the third generation partnership project (3GPP) releases for 5G NR so far, the buffer status of a UE refers to information about the volume of UL data that is buffered for one or more logical channel groups (LCGs) in the UE for transmission. The buffer status report (BSR) procedure is used by the UE to send a report of its buffer status to a gNB serving the UE to assist the gNB in scheduling the UL radio resource for the transmission of the UE.

### SUMMARY

Technical advantages are generally achieved, by embodiments of this disclosure which describe methods and apparatus.

According to embodiments, a user equipment (UE) sends, to a base station, a status report about data packets stored in a buffer of the UE. The data packets are associated with a logical channel group (LCG). The data packets include a first set of data packets and a second set of data packets. The status report indicates at least a first total size of the first set. The UE receives, from the base station, scheduling information. The UE transmits, to the base station, at least the first set stored in the buffer in accordance with the scheduling information.

In some embodiments, the UE may classify each data packet of the data packets as urgent or non-urgent based on comparing a first time threshold with a corresponding remaining time of the each data packet. In some embodiments, the UE may classify the each data packet by classifying a first packet as urgent based on a first remaining time of the first packet being less than or equal to the first time threshold and classifying a second packet as non-urgent based on a second remaining time of the second packet being greater than the first time threshold. In some embodiments, the UE may classify the each data packet by classifying the first packet as urgent based on the first remaining time of the first packet being less than the first time threshold and classifying the second packet as non-urgent based on the second remaining time of the second packet being greater than or equal to the first time threshold.

In some embodiments, the first set may include all urgent data packets of the data packets. The second set may include all non-urgent data packets of the data packets.

In some embodiments, the first set may include all urgent data packets of the data packets. The first set may be a subset of the second set. The second set may include all of the data packets.

In some embodiments, the first time threshold may be LCG-specific.

In some embodiments, the status report may be sent in one or more media access control (MAC) control elements (CEs). In some embodiments, the one or more MAC CEs may include a first MAC CE. The first MAC CE may include a first buffer size field indicating the first total size. In some embodiments, the status report may further indicate a second total size of the second set. In some embodiments, the first MAC CE may further include a second buffer size field indicating the second total size.

In some embodiments, the UE may send, to the base station, capability information indicating capabilities of the UE with regards to performing the classification and the reporting. The UE may receive, from the base station, configuration information for the UE to classify the each data packet. In some embodiments, the configuration information may indicate the first time threshold.

In some embodiments, the one or more MAC CEs may further include a second MAC CE. The second MAC CE may be one of legacy buffer status report (BSR) MAC CEs and include a second buffer size field indicating the second total size. In some embodiments, the legacy BSR MAC CEs may include at least one of a short BSR MAC CE, a short truncated BSR MAC CE, a long BSR MAC CE, or a long truncated BSR MAC CE.

In some embodiments, the first MAC CE may include an LCG identifier (ID) field indicating the LCG.

In some embodiments, the first MAC CE may further indicate that duration of a third remaining time to a delivery deadline associated with the first set is less than the first time threshold.

In some embodiments, the first MAC CE further include a remaining time duration field indicating the duration of the third remaining time.

In some embodiments, the scheduling information may indicate one or more radio resources. The UE may transmit, to the base station, the urgent data packets on the one or more radio resources. In some embodiments, the one or more radio resources may supplement a currently scheduled radio resource for the UE to transmit. In some embodiments, the UE may transmit, to the base station, the urgent data packets on the one or more radio resources and the currently scheduled radio resource.

In some embodiments, the sending of the status report may be in response to a second time threshold being greater than a corresponding remaining time of one data packet among the first set. In some embodiments, a value of the second time threshold may be indicated by the base station to the UE. In some embodiments, the value of the second time threshold may be determined as a value of the first time threshold subtracted by a value of a first time duration. In some embodiments, the value of the first time duration may be determined by the base station and indicated to the UE.

In some embodiments, a value of the first time threshold may be determined as a sum of the value of the second time threshold and a value of a second time duration. In some embodiments, the value of the second time duration may be determined by the base station and indicated to the UE.

In some embodiments, the first set may be a first data burst of data bursts received in a logical channel (LCH) of the LCG. The second set may be a second data burst of the data bursts. Each data burst of the data bursts may correspond to a respective delivery deadline. In some embodiments, the status report may further indicate duration of a fourth remaining time to a delivery deadline of the first data burst. In some embodiments, the UE may send, to the base station, a UE assistance information (UAI) indicating a nominal data burst arrival time offset at the LCH. In some embodiments, the UE may receive, from the base station, configuration information for reporting information about the data bursts. The UE may configure a MAC entity of the UE to send the status report in accordance with the configuration information.

According to embodiments, a base station receives, from a UE, a status report about data packets stored in a buffer of the UE. The data packets are associated with a logical channel group (LCG). The data packets include a first set of data packets and a second set of data packets. The status report indicates at least a first total size of the first set. The base station transmits, to the UE, scheduling information. The base station receives, from the UE, at least the first set stored in the buffer in accordance with the scheduling information.

In some embodiments, the base station may obtain information about a first remaining time duration to a first delivery deadline of the first set and a second remaining time duration to a second delivery deadline of the second set. In some embodiments, the first remaining time duration may be obtained from the status report received from the UE. The second remaining time duration may be derived based on the first remaining time duration. In some embodiments, the base station may receive, from the UE, information about a nominal data burst arrival time offset of the UE. The first remaining time duration and the second remaining time duration may be obtained based on the information about the nominal data burst arrival time offset and a time that the status report is received by the base station.

In some embodiments, the base station may send, to the UE, configuration information prior to the receiving of the status report. The configuration information may indicate to the UE to classify each data packet of the data packets as urgent or non-urgent in accordance with a corresponding remaining time associated with the each data packet. In some embodiments, the configuration information may indicate a first time threshold to the UE. The each data packet may be classified by the UE as urgent or non-urgent in accordance with a result of a comparison between the first time threshold and the corresponding remaining time associated with the each data packet. In some embodiments, the configuration information may further indicate a second time threshold to the UE. The receiving of the status report may indicate that the second time threshold is greater than a corresponding remaining time of at least one data packet among the first set. In some embodiments, a value of the second time threshold may be determined as a value of the first time threshold subtracted by a value of a first time duration. In some embodiments, the value of the first time duration may be determined by the base station and indicated to the UE in the configuration information. In some embodiments, a value of the first time threshold may be determined as a sum of a value of the second time threshold and a value of a second time duration. In some embodiments, the value of the second time duration may be determined by the base station and indicated to the UE in the configuration information.

In some embodiments, the first set may include all urgent data packets of the data packets. The second set may include all non-urgent data packets of the data packets.

In some embodiments, the first set may include all urgent data packets of the data packets. The first set may be a subset of the second set. The second set may include all of the data packets.

In some embodiments, the status report may be received in one or more media access control (MAC) control elements (CEs). In some embodiments, the one or more MAC CEs may include a first MAC CE. The first MAC CE may include a first buffer size field indicating the first total size. In some embodiments, the status report may further indicate a second total size of the second set. In some embodiments, the first MAC CE may further include a second buffer size field indicating the second total size. In some embodiments, the one or more MAC CEs may further include a second MAC CE. The second MAC CE may be one of legacy buffer status report (BSR) MAC CEs and include a second buffer size field indicating the second total size. In some embodiments, the legacy BSR MAC CEs may include at least one of a short BSR MAC CE, a short truncated BSR MAC CE, a long BSR MAC CE, or a long truncated BSR MAC CE.

In some embodiments, the first MAC CE may include an LCG identifier (ID) field indicating the LCG.

In some embodiments, the first MAC CE may further indicate that duration of a third remaining time to a delivery deadline associated with the first set is less than the first time threshold.

In some embodiments, the first MAC CE may further include a remaining time duration field indicating the duration of the third remaining time.

In some embodiments, the base station may obtain a first estimation of the first total size using a first information indicating the first total size in the status report and a first buffer size table. The base station may determine a need for scheduling an additional radio resource for the UE using the first estimation of the first total size. In some embodiments, buffer size levels in the first buffer size table may be computed as a linear function of buffer size indices in the first buffer size table. The first estimation of the first total size may be obtained as a buffer size level in the first buffer size table corresponding to a buffer size index in the first buffer size table. The buffer size index may be included in the status report for indicating the first total size.

In some embodiments, the configuration information may further indicate a second buffer size table to be used by the UE in determining the second total size. The base station may obtain a second estimation of the second total size using second information indicating the second total size in the status report and the second buffer size table. In some embodiments, the second buffer size table may be one of the first buffer size table or a legacy buffer size table. Buffer size levels in the legacy buffer size table may be computed as an exponential function of buffer size indices in the legacy buffer size table.

In some embodiments, the scheduling information may indicate one or more radio resources. The base station may receive, from the UE, the urgent data packets on the one or more radio resources. In some embodiments, the one or more radio resources may supplement a currently scheduled radio resource for the UE to transmit. In some embodiments, the base station may receive, from the UE, the urgent data packets on the one or more radio resources and the currently scheduled radio resource.

In some embodiments, the first set may be a first data burst of data bursts received in a logical channel (LCH) of the LCG. The second set may be a second data burst of the data bursts. Each data burst of the data bursts may correspond to a respective delivery deadline. In some embodiments, the status report may further indicate duration of a fourth remaining time to a delivery deadline of the first data burst.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a format of the short BSR MAC CE and the short truncated BSR MAC CE;

FIG. 2 illustrates a format of the long BSR MAC CE and the long truncated BSR MAC CE;

FIG. 3 illustrates example QoS flows, DRBs, and LCHs configured for an XR data PDU session on a UE, and various sublayer protocol entities, according to some embodiments;

FIG. 4 illustrates an example transmission buffer including N cascaded leaky buckets, according to some embodiments;

FIG. 5 illustrates a first example XR-BSR MAC CE format, according to some embodiments;

FIG. 6 illustrates a second example XR-BSR MAC CE format, according to some embodiments;

FIG. 7 illustrates a third example XR-BSR MAC CE format, according to some embodiments;

FIG. 8A illustrates an example where two LCHs are configured on a UE, according to some embodiments;

FIG. 8B illustrates a fourth example XR-BSR MAC CE format, according to some embodiments;

FIG. 9 illustrates a fifth example XR-BSR MAC CE format, according to some embodiments;

FIG. 10 illustrates a sixth example XR-BSR MAC CE format, according to some embodiments;

FIG. 11 illustrates a flow diagram of example operation flow occurring in a UE, according to some embodiments;

FIG. 12 illustrates a flow diagram of example operation flow 1200 occurring in a gNB, according to some embodiments;

FIG. 13 illustrates a seventh example XR-BSR MAC CE format, according to some embodiments;

FIG. 14 illustrates an eighth example XR-BSR MAC CE format, according to some embodiments;

FIG. 15 illustrates a ninth example XR-BSR MAC CE format, according to some embodiments;

FIG. 16 illustrates a flow diagram of example operation flow occurring in a UE, according to some embodiments;

FIG. 17 illustrates a flow diagram of example operation flow occurring in a gNB, according to some embodiments;

FIG. 18A shows a flow chart of a method performed by a UE, according to some embodiments;

FIG. 18B shows a flow chart of a method performed by a base station, according to some embodiments;

FIG. 19 illustrates an example communications system, according to embodiments;

FIG. 20 illustrates an example communication system, according to some embodiments;

FIGS. 21A and 21B illustrate example devices that may implement the methods and teachings according to this disclosure; and

FIG. 22 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

To enable the UE to transmit data on the UL, the gNB sends one or more radio resource control (RRC) signaling messages to the UE to configure the UE with a first number of signaling radio bearers (SRBs), a second number of DRBs, a third number of logical channels (LCHs), and a fourth number of LCGs, each LCH being associated with one SRB or DRB configured and being assigned to an LCG configured. In some embodiments, there can be up to eight LCGs configured for a regular UE, which is not an integrated access and backhaul mobile terminal (IAB-MT). Each LCG may include one or more LCHs.

In conventional 5G systems, for the purpose of buffer status reporting at the MAC sublayer, the UE calculates the data volume of data available at each LCH for UL transmission according to the following procedure:

First, the UE considers the following as the packet data convergence protocol (PDCP) data volume for each LCH associated with a transmitting PDCP entity of a DRB configured for the UE:
the PDCP SDUs for which no PDCP Data protocol data units (PDUs) have been constructed;
the PDCP Data PDUs that have not been submitted to lower layers;
the PDCP Control PDUs;
for acknowledged mode (AM) DRBs, the PDCP service data units (SDUs) to be retransmitted;
for AM DRBs, the PDCP Data PDUs to be retransmitted.

Then, the UE considers the following as the radio link control (RLC) data volume for the each LCH associated with a transmitting PDCP entity of a DRB configured for the UE:
RLC SDUs and RLC SDU segments that have not yet been included in an RLC data PDU;
RLC data PDUs that are pending for initial transmission;
LC data PDUs that are pending for retransmission (for RLC AM).

In addition, if a STATUS PDU has been triggered and t-StatusProhibit is not running or has expired, the UE estimates the size of the STATUS PDU that will be transmitted in the next transmission opportunity and consider this as part of the RLC data volume. Then, the UE sums up the PDCP data volume and the RLC data volume of each LCH to produce the total data volume of (data available for UL transmission for) the each LCH. The UE further sums up the total data volumes of LCHs assigned to a same LCG to produce the total data volume of data available for transmission for that LCG. The UE reports the total data volumes on a per-LCG basis, instead of a per-LCH basis, in order to minimize the signaling overhead.

A BSR is triggered if any of the following events occur for activated cell group:
1) UL data, for an LCH which belongs to an LCG, becomes available to the MAC entity, and either the UL data belongs to an LCH with higher priority than the priority of any LCHs containing available UL data which belong to any LCG or none of the LCHs which belong to an LCG contains any available UL data, in which case the BSR is referred to as a regular BSR;
2) UL resources are allocated and number of padding bits is equal to or larger than the size of a BSR MAC CE plus its MAC subheader, in which case the BSR is referred to as a padding BSR;
3) retxBSR-Timer expires, and at least one of the LCHs which belong to an LCG contains UL data, in which case the BSR is also referred to as a regular BSR;
4) periodicBSR-Timer expires, in which case the BSR is referred to as a periodic BSR.

For regular and periodic BSRs, if more than one LCG has data available for transmission when the MAC PDU containing the BSR is to be built, the MAC entity sends a long BSR MAC CE containing buffer size information for all LCGs that have data available for transmission. Otherwise, the MAC entity sends a short BSR MAC CE containing buffer size information for a single LCG.

For padding BSR, the MAC entity, based on the number (denoted as N) of LCGs that have data available for transmission when the BSR is to be built, selects a format among a short BSR MAC CE, a short truncated BSR MAC CE, a long BSR MAC CE, and a long truncated BSR MAC CE (details of which are described next), wherein the selected format contains buffer size information for a maximal number (denoted as M) of LCGs that have data and still fit into the number of (otherwise-would-be) padding bits. When M is less than N, the buffer size information of the top M LCGs, ranked by the highest priority LCH in each of the N LCGs, are reported in the padding BSR.

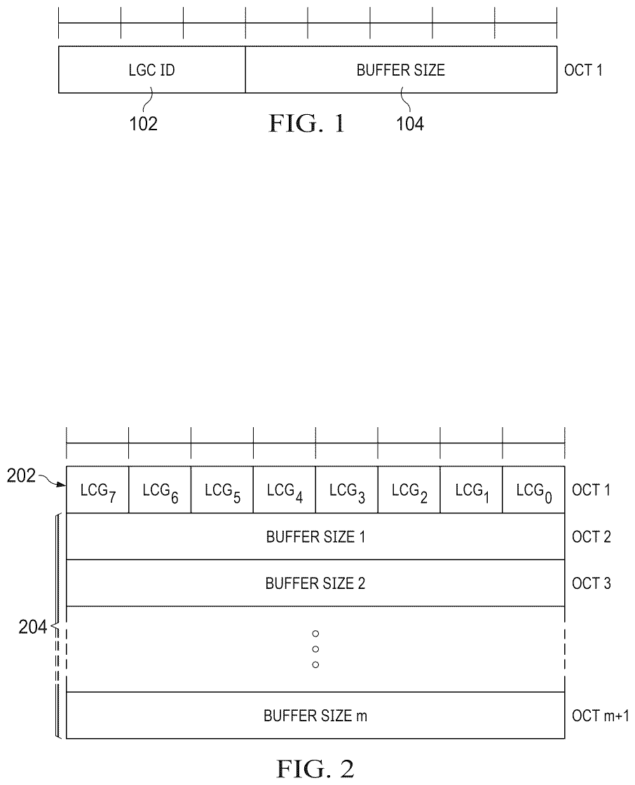

A BSR MAC CE sent by a UE that is not an IAB-MT can be one of short BSR, long BSR, short truncated BSR, or long truncated BSR MAC CE. The short BSR, long BSR, short truncated BSR, and long truncated BSR MAC CEs are identified by a logic channel identifier (LCID) value equal to 61, 62, 59, and 60, respectively, in the MAC subheader associated with the BSR MAC CE, in accordance with 3GPP Technical Specification (TS) 38.321. The format of the short BSR MAC CE and the short truncated BSR MAC CE is illustrated in FIG. 1. The format of the long BSR MAC CE and the long truncated BSR MAC CE is illustrated in FIG. 2.

The fields in these BSR MAC CEs are defined as follows:
LCG ID (field 102 in FIG. 1): The Logical Channel Group ID field identifies the group of LCH(s) whose buffer status is being reported. The length of the field is 3 bits;
LCGi (fields 202 in FIG. 2): For the long BSR format, the field LCGi indicates the presence (or absence) of the buffer size field for the LCG of which the LCG ID is equal to i. The LCG of which the LCG ID being equal to i is herein and hereafter denoted as the LCG (i), in order to differentiate from the LCGi field. The LCGi field set to 1 indicates that the Buffer Size field for the LCG (i) is reported (i.e., present in the BSR MAC CE). The LCGi field set to o indicates that the Buffer Size field for the LCG (i) is not reported (i.e., absent in the BSR MAC CE). For the long truncated BSR format, the field indicates whether the LCG (i) has data available. The LCGi field set to 1 indicates that the LCG (i) has data available. The LCGi field set to o indicates that the LCG (i) does not have data available;
Buffer Size (field 104 in FIG. 1 and fields 204 in FIG. 2): The Buffer Size field identifies the total amount of data available according to the data volume calculation procedure, as described before, across all LCHs of an LCG after the MAC PDU has been built (i.e. after the logical channel prioritization procedure, which may result the value of the Buffer Size field to zero). The amount of data is indicated in number of bytes. The size of the RLC headers and MAC subheaders are not considered in the buffer size computation. The length of this field for the short BSR format and the short truncated BSR format is 5 bits. The length of this field for the long BSR format and the long truncated BSR format is 8 bits. The values for the 5-bit and 8-bit Buffer Size fields are standardized in tables in TS 38.321. For example, Table 1 below shows the Buffer size levels (in bytes) for 5-bit Buffer Size field, as standardized in TS 38.321. For the long BSR format and the long truncated BSR format, the Buffer Size fields are included in ascending order based on the LCGi. For the long truncated BSR format, the number of Buffer Size fields included is maximized, while not exceeding the number of padding bits.

TABLE 1
Buffer size levels (in bytes) for 5-bit Buffer Size field

| | BS |
|---|---|
| Index | value |
| 0 | 0 |
| 1 | ≤10 |
| 2 | ≤14 |
| 3 | ≤20 |
| 4 | ≤28 |
| 5 | ≤38 |
| 6 | ≤53 |
| 7 | ≤74 |
| 8 | ≤102 |
| 9 | ≤142 |
| 10 | ≤198 |
| 11 | ≤276 |
| 12 | ≤384 |
| 13 | ≤535 |
| 14 | ≤745 |
| 15 | ≤1038 |
| 16 | ≤1446 |
| 17 | ≤2014 |
| 18 | ≤2806 |
| 19 | ≤3909 |
| 20 | ≤5446 |
| 21 | ≤7587 |
| 22 | ≤10570 |
| 23 | ≤14726 |
| 24 | ≤20516 |
| 25 | ≤28581 |
| 26 | ≤39818 |
| 27 | ≤55474 |
| 28 | ≤77284 |
| 29 | ≤107669 |
| 30 | ≤150000 |
| 31 | >150000 |

As Extended Reality (XR) applications are emerging as important driving forces for developing the next generation wireless communication technologies, they present technical challenges to the conventional approaches described above, due to their demands for support of high data throughputs, high system capacity, high reliability, and low latency simultaneously. In XR applications, the UL data traffic usually includes an audio stream, a sensing or pose data stream, and for augmented reality (AR), a video stream, each stream including periodic bursts of data with different periodicities and different delay requirements. For example, an audio packet may be generated every 10 milliseconds (msec) and has a delay budget of about 30 msec for the audio stream, a pose packet may be generated every 2.5 milliseconds (msec) and has a delay budget of about 10 msec for the pose stream, and for the UL video stream, a data burst including one or more packets corresponding to a video frame may be generated periodically (e.g., every 16.666 milliseconds (msec) for a frame refresh rate of 60 frames per second (FPS)), and has a delay budget of about 30 msec. For the sensing/pose data stream and the UL video stream, each packet should be transmitted from the UE to the gNB within the respective delay budget; otherwise, the packet may become unusable to the application layer (such as a graphics/rendering engine or a video decoder) on a destination (such as an XR application server in the cloud or edge cloud), or at least the user experience may suffer (e.g., the user may experience cyber-sickness, such as feeling dizzy, disoriented, and nauseous).

In addition, for the video stream, the total data volume of a burst of data packets that correspond to a same video frame changes from time to time, depending on the graphic content of the video frame as well as depending on how video compression is done on the video frame (e.g., whether the video frame is generated as an intra-coded frame (I-frame) or a predicted frame (P-frame)). Therefore, the size of the data bursts produced by the video stream varies from time to time, usually with significant difference existing between sizes of different types of frames (e.g., between sizes of I frames and sizes of P frames).

Generally speaking, a gNB can achieve a higher spectral efficiency in scheduling the transmission of an UL data if the data has a longer delay budget that allows the gNB to select a better transmission occasion for the UE to transmit the data.

For the various UL service streams, as described above, the packet delay budget (PDB) is usually longer than the corresponding traffic periodicity, which is the time interval between consecutive packets (e.g., for voice or pose stream) or between consecutive bursts of packets (e.g., for video stream). As a result, data in the transmission buffer of an LCH associated with an XR traffic may include multiple packets (e.g., for voice or pose stream), where each packet may be considered as a data burst consisting of a single packet, or multiple bursts of packets (e.g., for video stream), different bursts of packet(s) being generated at different points in time and hence having different amount of time remaining before the respective delivery deadlines. For example, some packets that arrived at the LCH during an earlier traffic cycle (and hence their delivery deadline may be fast approaching) may have an urgent need to be transmitted no matter how bad the current channel condition or interference condition on the UL is, while some other packets that just arrived may have a longer remaining time before their delivery deadline (and hence the gNB has more time to wait for a favorable channel condition and/or interference condition to schedule the transmission of them). However, in the current 5G NR, only the total data volume of an LCG is reported to the gNB, and no information is provided to the gNB about the remaining time to the respective delivery deadlines associated with the reported data, even if the data arrives periodically, like in the XR traffic. In this situation, a gNB compliant with the current 5G NR standards is unable to differentiate how many different bursts of data are being reported by the UE nor the remaining time for delivering the respective bursts of data reported by the UE. Therefore, the gNB usually considers all the data reported for the LCG as having the same level of urgency, in which case, the gNB may overly allocate transmission resources for the UE to empty all the data buffered for the LCG of the UE, when in reality, in the cases of periodical traffic such as XR traffic, only some data among the reported data volume (e.g., data arrived during an earlier traffic cycle) may need to be transmitted during the current transmission occasion while other data among the reported data volume (e.g., data arrived during a later traffic cycle) can afford to be transmitted at a later and more likely a better transmission occasion for better spectral efficiency.

For highly delay-sensitive traffic such as those XR service streams described above, the UE timely reporting the data volume of newly arrived data and remaining time for delivering the buffered data to the gNB is important for the gNB to schedule the transmission resources for the UE to transmit those data with high spectral efficiency. However, the current BSR triggering events 1), 2), and 3), as described above, are not designed for periodic data. The periodic BSR, as described above, is triggered upon the expiry of a periodicBSR-Timer. However, the periodicBSR-Timer is reset whenever a regular BSR or a padding BSR is sent due to any of events 1), 2), and 3). Once being reset, the expiry of the periodicBSR-Timer is no longer perfectly in synchrony with the packet arrival time or data burst arrival time, and as a result, the Periodic BSR triggered by the expiry of the periodicBSR-Timer may no longer be timely enough for meeting the delay requirement of the XR data.

This disclosure provides technical solutions for the UE to inform the gNB about newly arrived UL data for transmission as soon as possible, the data being associated with a periodic and delay-sensitive qualify of service (QOS) flow.

This disclosure provides technical solutions for the UE to report to the gNB not only data volume of data bursts arrived at an LCH (or an LCG consisting of a single LCH) on a per data burst basis but also information about remaining time for delivering the respective data bursts being reported, the data bursts arriving at the LCH at different points in time, the LCH being configured for the periodic and delay-sensitive QoS flow. Because supporting XR services has been one of this disclosure's motivations for developing the technical solutions described herein, this disclosure may refer this new buffer status report herein and hereafter as the XR-BSR to differentiate it from the legacy BSR, where the legacy BSR only reports a total data volume of an LCG without differentiating the respective data volumes associated with different remaining time durations nor indicating any remaining time. However, a different name for such report is also possible.

This disclosure provides technical solutions for the gNB to configure the UE to buffer data bursts periodically arrived at the LCH for UL transmission and to report information about data volume of respective data bursts being buffered, the report further explicitly or implicitly indicating information about the remaining time for delivering the respective data bursts being reported (i.e., the remaining time until (or to) the respective delivery deadlines of the data bursts being reported).

This disclosure provides technical solutions for the gNB to derive the information about the remaining time for delivering the respective data bursts reported by the UE, wherein the information about the remaining time may include different remaining time to the respective delivery deadlines of different data bursts reported by the UE, in order to assist the gNB in scheduling UL transmission for the UE in a spectral-efficient manner.

When a data PDU session with one or more periodic and delay-sensitive QoS flows (such as those associated with an XR application) is being established on a UE, the gNB serving the UE obtains information about the traffic periodicities and the PDBs or the PDU Set delay budgets (PSDBs) associated with the one or more QoS flows from a session management function (SMF) serving the data PDU session of UE.

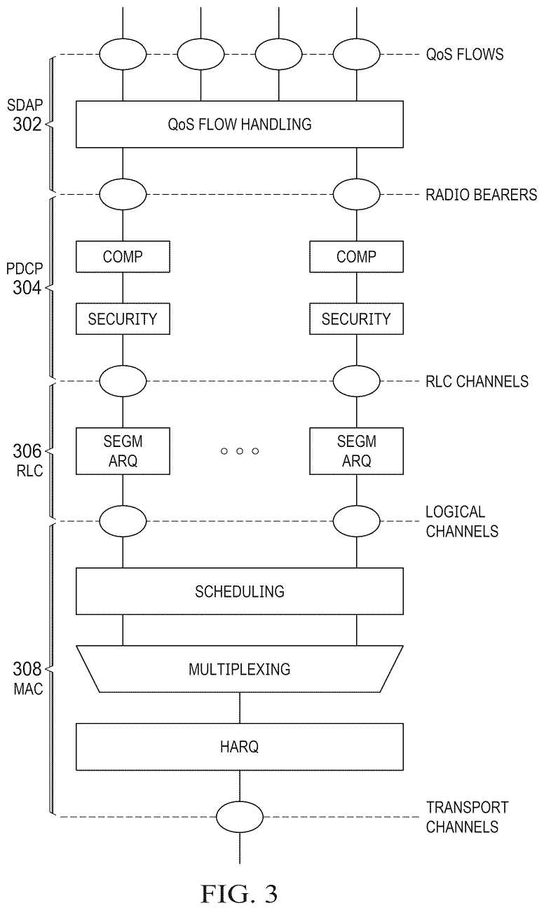

Then, the gNB configures the UE with one or more LCHs and one or more DRBs to serve the one or more QoS flows, each of the one or more LCHs being associated with one of the one or more DRBs. FIG. 3 illustrates example QoS flows, DRBs, and LCHs configured for an XR data PDU session on a UE, and various sublayer protocol entities (including service data adaptation protocol (SDAP) entity 302, PDCP entity 304, RLC entity 306, and MAC entity 308) of Layer 2 for processing data on the configured QoS flows, DRBs, and LCHs, respectively, for UL transmission.

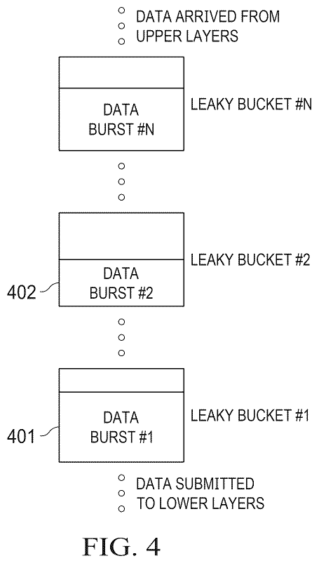

For an LCH among the one or more LCHs configured, the UE is configured by the gNB to report the data volumes of data arrived at the LCH on a per data burst basis (or per traffic cycle basis) (i.e., the UE may report multiple data volume information), each data volume information indicating the data volume of one data burst arrived at the LCH. When the traffic characteristics of packets of an LCH are quite different from those of other LCHs of the UE (e.g., the respective traffic periodicity and delay budget of a video stream, an audio stream, and a pose stream of an XR service may be quite different from one another), to keep the signaling message format for the UE reporting its buffer status on a per-LCG basis, a first LCH configured for the video stream may be assigned to a first LCG as the only LCH in the first LCG so that Buffer Size field(s) (as described below) corresponds to the first LCG indicates the data volume(s) of the respective data burst(s) of the first LCH only. Similarly, a second LCH and a third LCH configured for the audio stream and the pose stream, respectively, may be assigned to a second LCG and a third LCG, respectively. Alternatively, it is also possible to assign any combination of the first to the third LCHs to a same LCG. In some embodiments, the UE may be configured to store the data arrived at the LCH in a transmission buffer that includes N cascaded leaky buckets (which may also be referred to as sub-buffers, storage bins, etc.), where N is an integer greater than or equal to a delay budget (e.g., PDB or PSDB) of a QoS flow associated with the LCH divided by the traffic periodicity of the QoS slow. For example, the number N may be determined by the gNB and informed to the UE via the RRC signaling sent from the gNB to the UE. For example, for an UL video stream of an AR application, if the video refresh rate is 60 FPS and the PDB or PSDB is 30 msec, N is equal to ceiling (30/16.666) and hence equal to 2, where ceiling ( ) is the ceiling function. FIG. 4 illustrates an example transmission buffer including N cascaded leaky buckets, according to some embodiments. Among the N cascaded leaky buckets, a first leaky bucket (such as Leaky Bucket #1 401 in FIG. 4) at the bottom of the transmission buffer (i.e., being the egress point to the lower layers such as the MAC sublayer) is used for storing data of which the delivery deadline is within one traffic period, a second leaky bucket (such as Leaky Bucket #2 402 in FIG. 4) immediately above and logically connected to the first leaky bucket is used for storing data of which the delivery deadline is between one and two traffic periods away, a third leaky bucket immediately above and connected to the second leaky bucket is used for storing data of which the delivery deadline is between two and three traffic periods away, and so on and so forth. When the delivery deadline for the data in the first leaky bucket is reached, any data remaining in the first leaky bucket, whose transmission has not started yet or has not been completed yet, may be discarded and hence may no longer be counted for data volume calculation. Then, any data stored in the second leaky bucket are dumped (transferred and stored) into the first leaky bucket #1 401 in a first-in first-out (FIFO) order, any data stored in the third leaky bucket are then dumped into the second leaky bucket in the FIFO order, and so on and so forth. As a result, the N^{th} leaky bucket (such as Leaky Bucket #N in FIG. 4) at the top (i.e., the ingress point) of the transmission buffer may be emptied for new data to arrive within the next traffic period.

In some embodiments, all of the N cascaded leaky buckets are located within a transmitting unacknowledged mode (UM) RLC entity or the transmitting side of an acknowledged mode (AM) RLC entity configured to serve the LCH. In some other embodiments, some of the N cascaded leaky buckets (such as Leaky Bucket #N in FIG. 4) is or are located within the transmitting PDCP entity associated with the LCH, while the rest of the N cascaded leaky buckets are located within the transmitting (UM) RLC entity or the transmitting side of the (AM) RLC entity associated with the LCH.

The UE is configured to calculate and report the data volume (e.g., shown as the shaded areas in FIG. 4) of each data burst arrived at the LCH separately. For example, the UE may calculate the data volume of data stored in each of the N leaky buckets and to report the data volume of at least those leaky buckets that are not empty. In some embodiments, each leaky bucket (or each data burst) being reported is identified by a Bucket ID (or a Burst ID) field included in the XR-BSR.

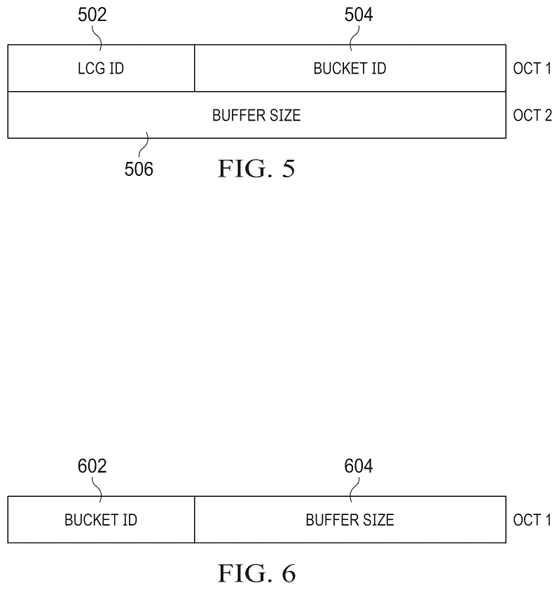

FIG. 5 illustrates a first example XR-BSR MAC CE format according to some embodiments, containing an LCG ID field 502 (e.g., with a length of 3 bits) identifying the LCG for which the data volumes of buckets (or data bursts) are being reported, a Bucket ID (or Burst ID) field 504 (e.g., with a length of 5 bits) identifying the bucket (or data burst) of which the data volume is being reported by an associated Buffer Size field, and the Buffer Size (or Burst Size) field 506 indicating the data volume of the bucket (or data burst) being reported for a bucket (or data burst) identified by the associated Bucket ID (or Burst ID) field 504, wherein the Bucket IDs are uniquely assigned to the leaky buckets configured within the same LCG. However, the Bucket IDs are not necessarily unique across different LCGs and hence the LCG ID field is included for unique identification. The values in the Buffer Size (or Burst Size) field 504 and the corresponding data sizes (e.g., in bytes) may be specified (e.g., in 3GPP TS 38.321), using a table similar to Table 1 above.

FIG. 6 illustrates a second example XR-BSR MAC CE format according to some embodiments, including the Bucket ID field 602 (e.g., with a length of 3 bits) and the Buffer Size field 604, wherein Bucket IDs are uniquely assigned to all the leaky buckets configured for the UE (hence the LCG ID field is unnecessary and omitted).

In some other embodiments, instead of individual Bucket IDs, a Bucket ID Bitmap (or Burst ID Bitmap) field carrying a bitmap is included in the XR-BSR, with each leaky bucket configured within an LCG or across different LCGs of the UE being uniquely associated with one bit in the bitmap. For example, when a bit in the Bucket ID Bitmap field is set to “1,” data volume in the corresponding leaky bucket is reported in the XR-BSR; otherwise, data volume in the corresponding leaky bucket is not reported in the XR-BSR.

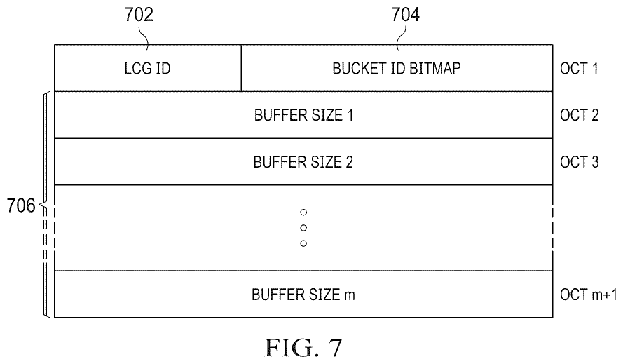

FIG. 7 illustrates a third example XR-BSR MAC CE format according to some embodiments, including the LCG ID field 702 (e.g., with a length of 3 bits), the Bucket ID Bitmap field 704 (e.g., with a length of 5 bits), and one or more Buffer Size (or Burst Size) fields 706 based on the number of bits being set to “1” in the Bucket ID Bitmap field 704, wherein the Bucket IDs are uniquely assigned to the leaky buckets configured within the same LCG. However, the Bucket IDs are not necessarily unique across different LCGs of the UE and hence the LCG ID field 702 is included for unique identification.

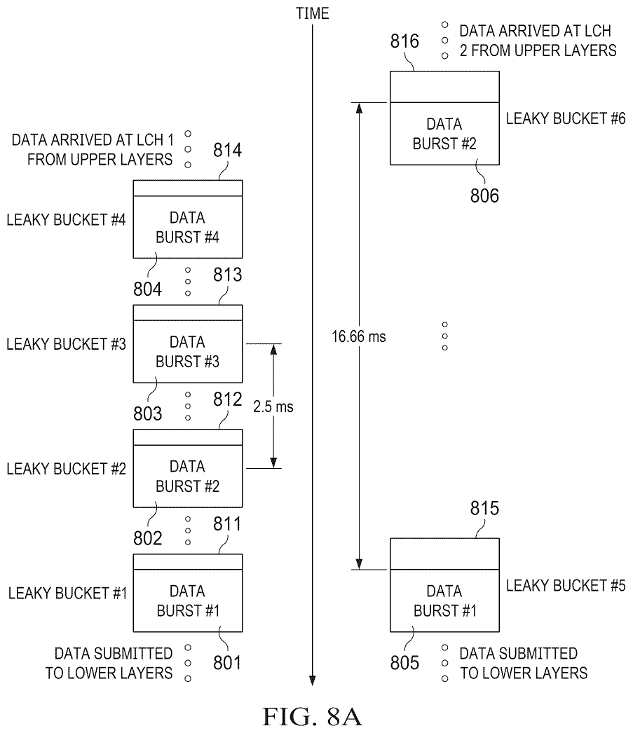

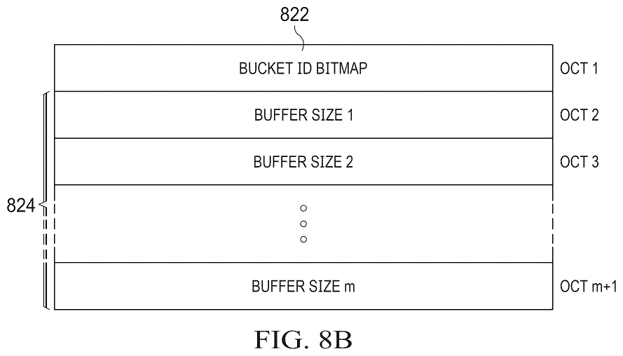

FIG. 8A illustrates an example where only two LCHs are configured on a UE, according to some embodiments. A first LCH (denoted as LCH 1 in FIG. 8A) is configured for the pose/control stream and is configured with a first transmission buffer including 4 cascaded leaky buckets, wherein the number of buckets being 4 is determined based on ceiling (10 msec/2.5 msec), i.e., there may be at most 4 different data bursts being stored for the first LCH at any time, such as data burst #1 801, data burst #2 802, data burst #3 803, and data burst #4 804. A second LCH (denoted as LCH 2 in FIG. 8A) is configured for the video stream and is configured with a second transmission buffer including 2 cascaded leaky buckets, wherein the number of buckets being 2 is determined based on ceiling (30 msec/16.666 msec), i.e., there may be at most 2 different data bursts being stored for the second LCH at any time, such as data burst #1 805 and data burst #2 806. The first LCH and the second LCH may be assigned to a same LCG or to different LCGs. As shown in FIG. 8A, all six leaky buckets (denoted as 811 to 816 in FIG. 8A) can be uniquely identified by an associated Bucket ID.

FIG. 8B illustrates a fourth example XR-BSR MAC CE format according to some embodiments, which can be used for the case illustrated in FIG. 8A. As shown in FIG. 8B, the fourth example XR-BSR MAC CE includes the Bucket ID Bitmap (or Burst ID Bitmap) field 822 (e.g., with a length of 8 bits) and one or more Buffer Size (or Burst Size) fields 824 based on the number of bits being set to “1” in the Bucket ID Bitmap field, wherein Bucket IDs are uniquely assigned to all the leaky buckets configured for the UE (hence the LCG ID field is unnecessary and omitted).

In yet some other embodiments, without physically using N cascaded leaky buckets, a burst of data arrived at an LCH may simply be labeled with a Burst ID equal to the number N and be stored in a transmission buffer configured for the LCH in the FIFO manner, where N is the integer greater than or equal to the delay budget (e.g., PDB or PSDB) of the QoS flow associated with the LCH divided by the traffic periodicity of the QoS slow, as described above. Then, for each passing traffic period, all the Burst IDs labeled with the stored bursts of data are decremented by 1 (equivalent to dumping the data to a bucket immediately below). In these embodiments, the first to the fourth example XR-BSR MAC CE formats illustrated in FIGS. 5-7 and 8B can be largely reused, except that the Bucket ID fields in FIGS. 5-7 and 8B are replaced by a Burst ID field indicating the Burst ID associated with a burst size being reported. The Buffer Size fields illustrated in FIGS. 5-7 and 8B may be replaced by a Burst Size field. The Bucket ID Bitmap fields illustrated in FIGS. 5-7 and 8B may be replaced by a Burst ID bitmap field. Data packets associated with Burst ID equal to o (zero) has the shortest remaining time for delivery.

In yet some other embodiments, without physically using N cascaded leaky buckets, the data arrived at an LCH may simply be labeled with a Burst sequence number (SN), where the UE and the gNB keeps tracking the Burst SN of newly arrived data burst by incrementing it by 1 for each traffic cycle, and then updating the Burst SN by computing the modulo of it over the number N, where N is the integer greater than or equal to the delay budget (e.g., PDB or PSDB) of the QoS flow associated with the LCH divided by the traffic periodicity of the QoS slow, as described before. In these embodiments, the first to the fourth example XR-BSR MAC CE formats illustrated in FIGS. 5-7 and 8B can be reused, except that the Bucket ID fields in FIGS. 5-7 and 8B are replaced by a Burst SN field indicating the Burst SN associated with a burst size being reported. The Buffer Size fields illustrated in FIGS. 5-7 and 8B may be replaced by a Burst Size field. The Bucket ID Bitmap fields illustrated in FIGS. 5-7 and 8B may be replaced by a Burst SN bitmap field.

One way for indicating the information about remaining time for each data burst being reported is to include a Remaining Time field for each of the Buffer Size (or Burst Size) fields being reported, each of the Remaining Time fields indicating the remaining time for delivering the data associated with a respective Buffer Size field being reported. However, this may result in higher signaling overhead when the number of data bursts (or leaky buckets) being reported increases.

The different cascaded leaky buckets configured for a same LCH are configured to store different bursts of data arrived at the LCH during different traffic cycles. Because the traffic jitters introduced on the UE side are relatively small due to lack of network jitters, the arrival time of two consecutive bursts of UL data are normally separated by one traffic period. Therefore, the remaining time for delivering data in the first leaky bucket plus one traffic period is normally equal to the remaining time for delivering data in the second leaky bucket immediately above the first leaky bucket, and the remaining time for delivering data in the first leaky bucket plus two traffic periods is normally equal to the remaining time for delivering data in the third leaky bucket immediately above the second leaky bucket, and so on and so forth. Therefore, if the remaining time for delivering data in the first leaky bucket is known to the gNB, the gNB may derive the remaining time for delivering data in the other leaky buckets accordingly.

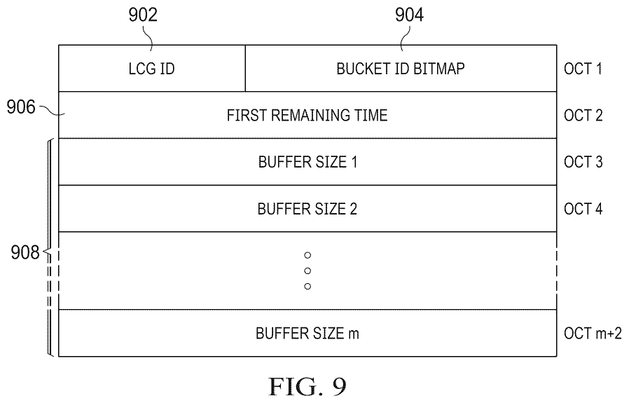

Hence, according to some other embodiments, only a first remaining time for delivering a data burst buffered in the first leaky bucket or in a first non-empty leaky bucket (i.e., a data burst that has the shortest remaining time for delivery) is explicitly indicated in the XR-BSR sent to the gNB. The gNB derives the remaining time for delivering the other leaky buckets (or data bursts) based on the first remaining time being reported and the nominal temporal relationship (e.g., separated by an integer number of traffic periods) between the leaky buckets (or the data bursts) being reported. FIG. 9 illustrates yet a fifth example XR-BSR MAC CE format, including the LCG ID field 902 (e.g., with a length of 3 bits), the Bucket ID Bitmap field 904 (e.g., with a length of 5 bits), a First Remaining Time field 906 (e.g., with a length of 8 bits) indicating the remaining time associated with the data burst in the first leaky bucket or in a first non-empty leaky bucket being reported, and one or more Buffer Size (or Burst Size) fields 908 based on the number of bits being set to “1” in the Bucket ID Bitmap field, wherein the Bucket IDs are uniquely assigned to the leaky buckets configured within the same LCG. However, the Bucket IDs are not necessarily unique across different LCGs of the UE and hence the LCG ID field 902 is included for unique identification.

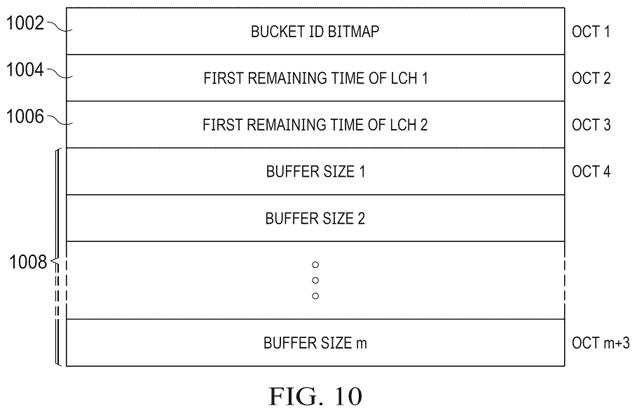

FIG. 10 illustrates a sixth example XR-BSR MAC CE format that is suitable for the case illustrated in FIG. 8A, according to some embodiments. As shown in FIG. 10, the sixth example XR-BSR MAC CE format contains the Bucket ID Bitmap field (e.g., with a length of 8 bits) 1002, a First Remaining Time field 1004 (occupying October 2 in FIG. 10) indicating the remaining time associated with the data burst in the first leaky bucket (such as Leaky Bucket 601 in FIG. 8A) or in a first non-empty leaky bucket being reported for a first LCH or LCG (such as LCH 1 in FIG. 8A), another First Remaining Time field 1006 (occupying October 3 in FIG. 10) indicating the remaining time associated with the data burst in the first leaky bucket (such as Leaky Bucket 605 in FIG. 8A) or in a first non-empty leaky bucket being reported for a second LCH or LCG (such as LCH 2 in FIG. 8A), and one or more Buffer Size (or Burst Size) fields 1008 based on the number of bits being set to “1” in the Bucket ID Bitmap field, wherein Bucket IDs are uniquely assigned to all the leaky buckets configured for the UE (hence the LCG ID field is unnecessary and omitted).

In yet some other embodiments, the nominal data burst arrival time at the UE, which may be expressed as a time offset to a reference time, is known to the gNB and the UE. For example, the UE measures the nominal data burst arrival time of a periodic bursty data traffic as the time offset to the reference time and then informs the gNB about the amount of the time offset. For another example, the network configures the UE to generate the periodical bursty data traffic with a specified time offset to a reference time, and the network also informs the gNB about the amount of the time offset. Hence, when the gNB receives an XR-BSR from the UE, the gNB computes the time elapsed since the arrival of the oldest data burst (e.g., corresponding to the data burst stored in the Leaky Bucket 401 in FIG. 4), and then, based on the time elapsed, computes the remaining time of the oldest data burst (or data burst in the lowest leaky bucket), and then, based on the remaining time of the old data burst (or the data burst in the lowest leaky bucket) and traffic periodicity, computes the remaining time for the subsequent data bursts (or data bursts in higher leaky buckets). In these embodiments, all the remaining times are implicitly indicated and derived by the gNB based on the time that it receives the XR-BSR, and hence the first to the fourth example XR-BSR MAC CE formats illustrated in FIGS. 7 and 8B can be used, instead of using the fifth or the sixth example XR-BSR MAC CE formats illustrated in FIGS. 9-10.

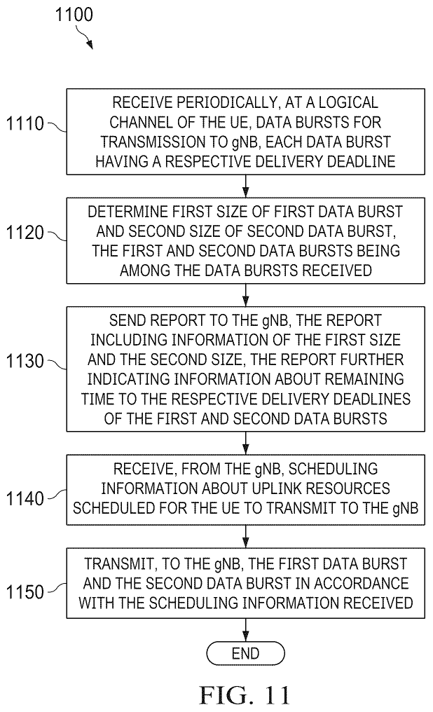

FIG. 11 illustrates a flow diagram of example operation flow 1100 occurring in a UE. Operation flow 1100 may be indicative of operations occurring in a UE, as the UE reports its buffer status on one or more logical channels of the UE, to a gNB serving the UE, on a per data burst basis and with information being explicitly or implicitly indicated about remaining time for delivering the respective data bursts being reported.

Operation flow 1100 begins with the UE receiving periodically, at a logical channel of the UE, data bursts for transmission to a gNB serving the UE, each of the data bursts having a respective delivery deadline (operation 1110). The UE determines a first size of a first data burst and a second size of a second data burst, the first and second data bursts being among the data bursts received (operation 1120). The UE sends a report to the gNB, the report including information of the first size and the second size (operation 1130). For example, the report may include one instance of the third to the sixth example XR-BSR MAC CEs, as illustrated in FIGS. 7, 8B, 9, and 10, respectively. For another example, the report may include more than one instances of the first or more than one instances of the second example XR-BSR MAC CES illustrated in FIGS. 5-6, respectively. The report may further indicate, explicitly or implicitly information about remaining time to the respective delivery deadlines of the first and second data bursts. For example, the report further includes information of a remaining time duration to the delivery deadline of the first data burst being reported, as illustrated in FIG. 9. The report may further include the size information and the remaining time information about one or more data bursts arrived at a second logical channel of the UE for transmission to the gNB. For example, the report may include one instance of the sixth example XR-BSR MAC CE illustrated in FIG. 10 or more than one instances of the first to the fifth example XR-BSR MAC CEs, as illustrated in FIGS. 5-7, 8B, and 9, respectively.

The UE receives, from the gNB, scheduling information about uplink resources scheduled by the gNB for the UE to transmit to the gNB (operation 1140). For example, the scheduling information may be included in a downlink control information (DCI) received on a physical downlink control channel (PDCCH). Then, the UE transmits, to the gNB, the first data burst and the second data burst in accordance with the scheduling information received (operation 1150). Then, operation flow 1100 may end.

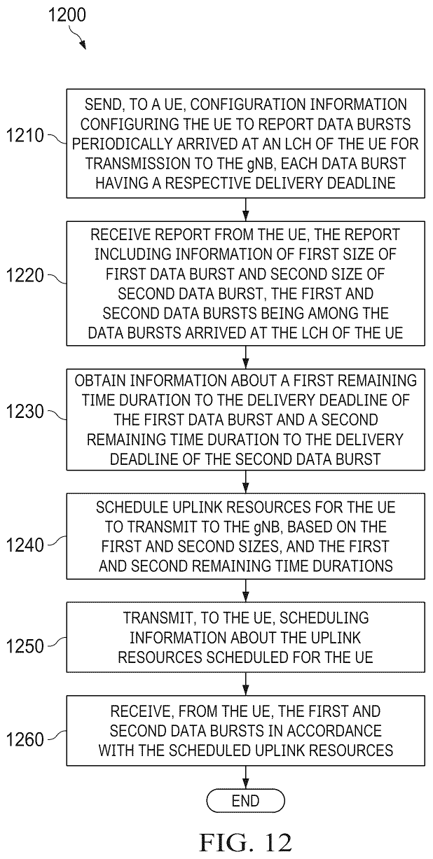

FIG. 12 illustrates a flow diagram of example operation flow 1200 occurring in a gNB, according to some embodiments. Operation flow 1200 may be indicative of operations occurring in a gNB, as the gNB configures a UE to report the size of each of one or more data bursts buffered at one or more logical channels of the UE for transmission, obtains information about remaining time to the respective delivery deadlines of the one or more data bursts reported by the UE, and based on information including the size information reported and the remaining time information obtained, schedules uplink resources for the UE to transmit to the gNB.

Operation flow 1200 begins with the gNB sending, to a UE served by the gNB, configuration information configuring the UE to report data bursts periodically arrived at a logical channel of the UE for transmission to the gNB, each data burst having a respective delivery deadline (operation 1210). The gNB receives a report from the UE, the report including information of a first size of a first data burst and a second size of a second data burst, the first and second data bursts being among the data bursts arrived at the logical channel of the UE for the transmission to the gNB (operation 1220). For example, the report may include one instance of the first to the fourth example XR-BSR MAC CE, as illustrated in FIGS. 7, 8B, 9, and 10. For another example, the report may include more than one instances of the fifth or more than one instances of the sixth example XR-BSR MAC CEs illustrated in FIGS. 5-6, respectively. The report may further indicate, explicitly or implicitly information about remaining time to the respective delivery deadlines of the first and second data bursts. For example, the report further includes information of a remaining time duration to the delivery deadline of the first data burst being reported, as illustrated in FIG. 9. The report may further include the size information and the remaining time information about one or more data bursts arrived at a second logical channel of the UE for transmission to the gNB. For example, the report may include one instance of the sixth example XR-BSR MAC CE illustrated in FIG. 10 or more than one instances of the first to the fifth example XR-BSR MAC CEs, as illustrated in FIGS. 5-7, 8B, and 9, respectively.

The gNB obtains information about a first remaining time duration to the delivery deadline of the first data burst and a second remaining time duration to the delivery deadline of the second data burst (operation 1230). For example, the gNB may receive both the first remaining time duration and the second remaining time duration directly in the report from the UE. For another example, the gNB may receive the first remaining time duration directly in the report from the UE and derive the second remaining time duration based on the first remaining time duration received and a temporal relationship between the first and second data bursts. For example, if the first and second data bursts are identified as two consecutive data bursts of the periodic stream (e.g., based on their Bucket IDs, Burst IDs, or their corresponding bit positions in the bitmap in the reported example XR-BSR MAC CE, as illustrated in FIGS. 5-7, 8B, and 9-10 and described previously), then the second remaining time duration can be derived as the sum of the first remaining time duration and one traffic period. For yet another example, the gNB derives the first remaining time duration based on a time that the report is received from the UE, information of a nominal burst arrival time offset of the UE, the time offset information being provided to the gNB by the UE or by an SMF serving the UE, and information of a PDB or PSDB of the UE, and then the gNB derives the second remaining time duration based on the first remaining time duration and the temporal relationship between the first and second data bursts, as described before.

The gNB schedules uplink resources for the UE to transmit to the gNB, based on information including the first and second sizes, and the first and second remaining time durations (operation 1240). Then, the gNB transmits, to the UE, scheduling information about the uplink resources scheduled for the UE (operation 1250). For example, the gNB may transmit a DCI to the UE using the PDCCH, the DCI including the uplink scheduling information, and a cyclic redundancy check (CRC) carried on the PDCCH being scrambled with a radio network temporary identifier (RNTI) of the UE. The gNB receives, from the UE, the first and second data bursts in accordance with the scheduled uplink resources (operation 1260). Then, operation flow 1200 may end.

This disclosure provides an XR-BSR procedure for the UE to report, to a gNB serving the UE, information about data volume for UL data arrived at an LCH on a per data burst basis, the LCH being configured for a QoS flow with bursts of data packets periodically arriving for transmission and the delay budget for the transmission being short. The XR-BSR sent by the UE also explicitly or implicitly indicates, to the gNB, information about remaining time until a delivery deadline for each of the data burst being reported, and the information about the data volume reported and the information about the remaining time explicitly or implicitly indicated enable the gNB to schedule UL transmission in a spectrum-efficient way. This disclosure provides various XR-BSR signaling message formats including new information for identifying one or more data bursts being reported. This disclosure provides a signaling mechanism for the gNB to configure the UE to perform the reporting based on QoS requirements and QoS parameters that the gNB received from the SMF.

For the various UL service streams, as described above, the PDB is usually longer than the corresponding traffic periodicity (the time interval between consecutive packets or between consecutive bursts of packets), which means at a given time, data in the transmission buffer of an LCH associated with an XR traffic may include multiple bursts of packets, each bursts of packets being generated at different points in time and hence having different amount of time remaining before the respective delivery deadlines. For example, some packets that arrived at the LCH during an earlier traffic cycle (and hence their delivery deadline may be fast approaching) may have an urgent need to be transmitted regardless of the current channel condition or interference condition on the UL, while some other packets that just arrived at the same LCH may have a longer remaining time before their delivery deadline (and hence the gNB has more time to wait for a favorable channel condition and/or interference condition to schedule the transmission of them). However, the legacy BSR procedures and legacy BSR MAC CEs currently defined in 3GPP TS 38.321 only contain information of a total data volume for each LCG reported, without information to distinguish the sizes of different data bursts stored in a same buffer, or information of respective remaining time for delivering them before their associated delivery deadlines, or information to distinguish the sizes of urgent PDUs (i.e., packets) and non-urgent PDUs.

Without ability to differentiate what amount of data being reported for an LCG of the UE is urgent or non-urgent, the gNB usually considers all the data being reported as having the same level of urgency, in which case, the gNB may overly allocate radio resources for the UE to transmit all the data buffered at the LCG, when in reality only some data among the data reported for the LCG need to be transmitted during a current traffic cycle while other data among the data reported can afford to be transmitted at later cycle with better spectral efficiency.

This disclosure provides technical solutions for a UE to classify each PDU of PDUs in a buffer associated with an LCG of the UE as an urgent PDU or a non-urgent PDU based on specific criteria, and to report a total size of urgent PDUs buffered for the LCG distinctively from a total size of non-urgent PDUs buffered for the LCG when reporting a buffer status to gNB serving the UE. The solutions of reporting the total sizes distinctively include informing the gNB at least the total size of the urgent PDUs, if there are any, to ensure that the urgent PDUs are delivered to the gNB within associated deadline.

This disclosure provides technical solutions for gNB to ensure sufficient radio resources for UE to deliver PDUs in a buffer of the UE to the gNB within the associated deadlines. The technical solutions may include techniques for the gNB to be informed of a first total size of urgent PDUs buffered at an LCG of the UE, remaining time associated with the urgent PDUs being within a specific time threshold (or within a specific time range) when being informed of the first total size, techniques for the gNB to determine whether the radio resource currently scheduled for the UE to transmit is sufficient for the UE to deliver the urgent PDUs buffered at the LCG of the UE to the gNB within the associated deadline, and in response to determining the currently scheduled radio resource being insufficient, techniques for the gNB to schedule additional radio resource for the UE to transmit. The technical solutions of scheduling the additional radio source may include allowing the UE to deliver the urgent PDUs within the associated deadline.

This disclosure provides signaling techniques for the UE to indicate, to the gNB, its capability of performing the classification of PDUs and the reporting of buffer status, as described herein, and signaling techniques for the gNB to configure the UE to perform the classification and the reporting.

For scheduling a UE to transmit a periodic traffic to a gNB, the gNB typically uses a configured grant (CG), which is sent to the UE via an RRC signaling message dedicated to the UE, the CG providing scheduling information of periodic radio resources for the UE to transmit with a repetitive transmission pattern that usually matches with the traffic pattern, without a need for the gNB to send the scheduling information dynamically via the physical downlink control channel (PDCCH) each time that the UE is scheduled to transmit. The amount of the periodic radio resources for each traffic cycle is typically determined based on the average size of one data burst in the traffic. The scheduling mechanism of using CG is also referred to as grant free scheduling. It works well in avoiding the sending of the scheduling information dynamically via the PDCCH when the size of each data burst of the periodic traffic is relatively constant (e.g., when the periodic traffic is a voice traffic, or when the periodic traffic is not delay-sensitive, for instance, when the periodic traffic is for a video streaming service), which usually allows several to tens of seconds worth of video data be downloaded and buffered in advance at the data recipient before the associated deadlines for playing them out, respectively. However, an XR video traffic not only is very delay-sensitive but also has a data burst size that tends to change from burst to burst or from frame to frame, as described before. Hence, even if CG is used on an XR UE, adjustment to the CG-scheduled radio resource for the UE may be needed from time to time (e.g., by supplementing the CG-scheduled radio source with additional radio source that is dynamically scheduled with one or more dynamic grants (DGs) sent to the UE via the PDCCH).

Thus, in accordance with various embodiments described herein, the UE determines whether each PDU buffered at an LCG of the UE is an urgent PDU or a non-urgent PDU based on a comparison between a remaining time associated with the each PDU and a time threshold pre-specified or configured for the LCG of the UE. The UE further calculates a first total size of all urgent PDUs buffered at the LCG and a second total size of all non-urgent PDUs buffered at the LCG. The UE indicates the first total size distinctively from the second total size when reporting a buffer status to a gNB serving the UE. In a first embodiment, the initiation of the sending of such status report (an XR-BSR) may be triggered by the first total size being non-zero, i.e., when a respective remaining time of at least one data packet buffered for the LCG is below the time threshold, hence the reporting (e.g., the XR-BSR) further indicating the remaining time associated with the first total size being less than or equal to the time threshold. However, in some situation, a burst of data packets belonging to a same PDU Set may have arrived not precisely at a same time instance but in close proximity in time. In this case, if the XR-BSR is triggered by the first (the earliest) data packet of the burst of data packets, it is possible that the respective remaining time of some later arrived data packets of the same data burst may have not dropped below the time threshold, and hence their data volume may not be counted for at the time when the XR-BSR is generated and sent. So, the reported data volume may be under-counted and/or the later arrived data packet(s) may have to trigger another XR-BSR in a close proximity in time, causing undesirable signaling overhead. Alternatively, in a second embodiment, in additional to the time threshold (which is also referred to as the urgency time threshold) provided to the UE for determining the urgency (i.e., urgent vs. non-urgent) of the UL data packets of the LCG of the UE, the UE may be provided with a second time threshold (which is also referred to as the reporting time threshold) for determining when to initiating the sending of an XR-BSR, a value of the reporting time threshold being smaller than a value of the urgency time threshold (meaning that a threshold time point for reporting XR-BSR for a data packet is closer to the respective delivery deadline of the data packet than a demarcation time point for determining urgency of the data packet to the respective delivery deadline). When a respective remaining time of any data packets buffered for the LCG has dropped below the reporting time threshold, the UE initiates the sending of an XR-BSR. The initiation may include the UE determining a next available UL transmission opportunity or, e.g., when no such transmission opportunity exists, sending a service request (SR) signal or a random access (RA) signal to request the gNB to schedule an UL transmission opportunity. When the UL transmission opportunity is present, the UE determines the first total size to be reported in the XR-BSR as the total data volume of all urgent data packets of the LCG that are determined as being urgent using the urgency time threshold at the time the XR-BSR is to be generated and sent. In this way, the XR-BSR is triggered by the earliest data packet of the burst of data packets while the total data volume being reported as being urgent captures all data packets of the burst of the data packets. In this case, if a remaining time information is explicitly included in the XR-BSR, it should indicate the shortest remaining time among all the urgent data packets (of which the first total size) being reported and the gNB should interpret it as if the first total size being reported is associated with the (shortest) remaining time being indicated (even if it may not be true for all the urgent data packets being reported). If no remaining time information is explicitly included in the XR-BSR, the gNB should interpret that the first total size being reported is associated with a remaining time below the reporting time threshold (even though it may not be true for all the urgent data packets being reported). In the first embodiment described above, one may consider the reporting time threshold (although not separately provided) as being equal to the urgency time threshold, while in the second embodiment described above, the reporting time threshold being smaller (closer to delivery deadline) than the urgency time threshold. Yet alternatively, in a third embodiment, the urgency time threshold may be determined as a sum of the reporting time threshold and a specific margin time duration. For example, both a first value of the reporting time threshold and a second value of the margin time duration may be determined by the gNB and indicated to the UE through configuration, e.g. the gNB may determine the margin time duration based on how wide, in time, the multiple physical uplink shared channel occasions (PUSCH-Os) (within each traffic cycle) in the CG scheduled by the gNB for the UE are spread, or in the case of different traffic streams of multi-modality services being mapped onto the same LCG, based on the time synchronization error (or margin) between the respective starting points of the corresponding traffic cycles of different traffic streams. For another example, the first value of the reporting time threshold may be determined by the gNB and indicated to the UE through configuration while the second value of the margin time duration may be determined by a local configuration of the UE or by the UE based on how wide the multiple PUSCH-Os (within each traffic cycle) in the CG scheduled for the UE are spread or based on the time synchronization error/margin of the multi-modality services. Then, in each of both examples, the UE determines the urgency time threshold accordingly (by computing the sum as described above) and applies it for the classifying of each data packet. Yet alternatively, in a fourth embodiment, the reporting time threshold may be determined as the urgency time threshold subtracted by a specific advance-warning time duration. For example, both a third value of the urgency time threshold and a fourth value of the advance-warning time duration may be determined by the gNB and indicated to the UE through configuration, e.g., the gNB may determine the advance-warning time duration based on how wide, in time, the multiple PUSCH-Os (within each traffic cycle) in the CG scheduled by the gNB for the UE are spread, or in the case of different traffic streams of multi-modality services being mapped onto the same LCG, based on the time synchronization error (or margin) between the respective starting points of the corresponding traffic cycles of different traffic streams. For another example, the third value of the urgency time threshold may be determined by the gNB and indicated to the UE through configuration while the fourth value of the advance-warning time duration may be determined by a local configuration of the UE or by the UE based on how wide the multiple PUSCH-Os (within each traffic cycle) in the CG scheduled for the UE are spread or based on the time synchronization error/margin of the multi-modality services. Then, in each of both examples, the UE determines the reporting time threshold accordingly (by computing the subtraction as described above) and applies it for the triggering of the XR-BSR. In the above four examples, each of the first to the fourth values may be provided and applied on a per-LCG basis.

Based on the buffer status (an XR-BSR) reported by the UE, the gNB determines whether the radio resource, if there is any, currently scheduled (e.g., using a CG) for the UE to transmit within a period upon receiving the report, is sufficient for the UE to deliver the urgent PDUs to the gNB within the period, the period having a specific duration that is less than or equal to the time threshold (e.g., the reporting time threshold). The sufficiency may be evaluated considering the possible time duration needed for retransmit any PDUs lost in transmission until the transmission succeeds within the period. In response to determining the currently scheduled radio resource, if there is any, being insufficient, the gNB schedules additional radio resource for the UE to transmit (e.g., by using one or more DGs sent to the UE via the PDCCH), the currently scheduled radio resource, if any, and the additionally scheduled radio resource together allowing the UE to deliver at least the urgent PDUs to the gNB within the period.

As the UE periodically receives a burst of data (data burst) on a DRB of the UE from associated upper layer for transmission, the UE processes SDUs received to produce corresponding PDUs, respectively, and stores the produced PDUs in a buffer associated with an LCG of the UE, the DRB being configured for the UE to support a real-time multimedia service such as an XR video service, the LCG being configured for the UE in association with the DRB, the data burst including one or more PDU sets, each PDU set including one or more SDUs, and each PDU Set and/or each SDU being associated with a corresponding deadline for delivery to a gNB serving the UE. For each PDU buffered for the LCG (i.e., stored in the buffer associated with the LCG), the UE keeps tracking a remaining time to a delivery deadline associated with the each PDU. For example, the UE may use a timer referred to as the discardTimer and associated with a PDCP SDU received from associated upper layer for transmission to determine the remaining time associated with the corresponding PDU(s), such as the PDCP PDU and associated RLC PDU(s) corresponding to the same PDCP SDU.

The UE classifies each PDU in the buffer as an urgent or non-urgent PDU based on a time threshold (or an urgency time threshold) and the remaining time associated with the each PDU. For example, when remaining time of a PDU is less than or equal to the (urgency) time threshold, the PDU is classified as an urgent PDU; otherwise, the PDU is classified as a non-urgent PDU. In one example, the (urgency) time threshold is determined by the gNB (e.g., based on an amount of time that the gNB needs to respond to a critical condition (such as too much urgent data pending a transmission at the UE) revealed by the XR-BSR from the UE), and is provided to the UE by the gNB using a control plane message such as an RRC Setup or RRC Reconfiguration message sent from the gNB to the UE. In another example, the (urgency) time threshold is pre-specified (e.g., in standards), and is therefore known to the UEs and the gNBs in compliance with the standards. The classifying is an on-going process (e.g., as time goes by), such that when remaining time of a previously non-urgent PDU becomes less than or equal to the (urgency) time threshold, the PDU is re-classified as an urgent PDU. The urgent PDUs may also be referred by other names, such as priority PDUs, high priority PDUs, Priority A PDUs, or Type A PDUs, etc. The non-urgent PDUs may also be referred by other names, such as non-priority PDUs, low priority PDUs, regular PDUs, Priority B PDUs, or Type B PDUs, etc.

The UE calculates the total data volume of urgent PDUs buffered for an LCG of the UE as a first total size associated with the LCG and the total data volume of non-urgent PDUs buffered for the LCG as a second total size associated with the LCG. The calculating is also an on-going process (e.g., as time goes by), where the classification result may change or new data burst may arrive, and hence as a result, the calculating result is updated accordingly.

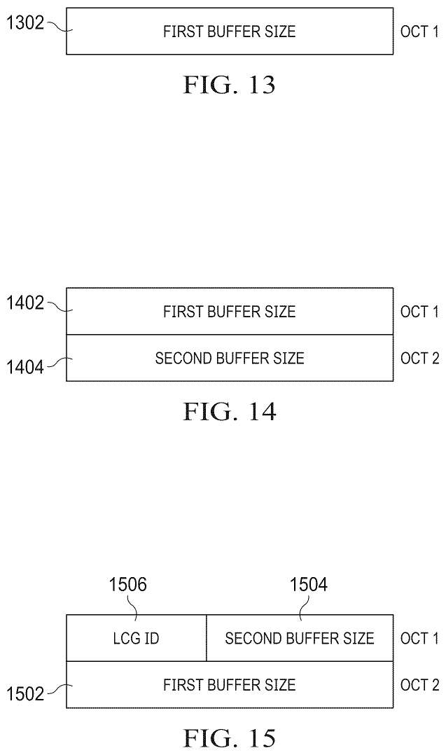

In accordance with one example embodiment, when the first total size of the LCG is reported, the first total size is indicated by information included in a new MAC CE referred to as the XR-BSR MAC CE. Another name for the new MAC CE is also possible. The XR-BSR MAC CE is identified by a new LCID or a new extended LCID (eLCID), a value of which is to be specified in the standard (such as TS 38.321) as such to identify the XR-BSR MAC CE, the LCID or the eLCID being included in a MAC subheader associated with the XR-BSR MAC CE. In accordance with a seventh example XR-BSR MAC CE format, as illustrated in FIG. 13, the seventh example XR-BSR MAC CE comprises a First Buffer Size field 1302 indicating the first total size of the LCG being reported, value in the First Buffer Size field being determined by the UE and interpreted by the gNB in accordance with a look-up table (e.g., a new Buffer Size table referred to the XR Buffer Size table). Another name for the new Buffer Size table is also possible. One benefit of introducing the new XR Buffer Size table, comparing to the legacy tables such as Table 1 illustrated before, is that the buffer size levels (e.g., in bytes) can be computed as a linear function of the buffer size index (i.e., the value carried in a Buffer Size field), as opposed to the exponential function used in the legacy Buffer Size tables. The distribution of quantization errors for a Buffer Size table using a linear function is more uniform than that for the legacy Buffer Size table using the exponential function. Another benefit of introducing the new XR Buffer Size table is that the range of buffer size levels covered by the table can be narrowed to a range that is suitable for XR services so that quantization errors can be further reduced. Reducing the quantization error in reporting a buffer size can help the gNB to schedule the right amount of radio resource for the pending transmission of the UL data, and hence improving the spectral efficiency in the UL transmissions. In accordance with an eighth example XR-BSR MAC CE format, as illustrated in FIG. 14, the eighth example XR-BSR MAC CE comprises the First Buffer Size field 1402, which is same as the First Buffer Size field 1302 described above, and a Second Buffer Size field 1404 indicating the second total size of the same LCG. The value in the Second Buffer Size field 1404 may be determined and interpreted in accordance with the XR Buffer Size table or the legacy Buffer Size table, whichever is configured by the gNB to be used on the second total size. In accordance with a ninth example XR-BSR MAC CE format, as illustrated in FIG. 15, the ninth example XR-BSR MAC CE comprises the First Buffer Size field 1502 and the Second Buffer Size field 1504, which respectively indicates the same as the First Buffer Size field 1302 and the Second Buffer Size field 1404 described above, and an LCG ID field 1506 indicating the LCG being reported. As a result of inserting the LCG ID field 1506 without increasing the total length, the Second Buffer Size field 1504 may be shortened to a 5-bit field, as shown in FIG. 15, resulting in larger quantization errors. However, the larger quantization errors may have little or only small impact on the gNB's scheduling because some, if not all, of the non-urgent PDUs will become urgent PDUs soon or later, and then as such, their size will be reported in the First Buffer Size field 1502, with smaller quantization errors, in another XR-BSR sent after they have become the urgent PDUs.

The seventh and the eighth example XR-BSR MAC CE formats, as described above and illustrated in FIGS. 13 and 14, respectively, may be suitable for the case where there is only one LCG among the LCGs of a UE, the XR-BSR on which is configured to have the first total size of the urgent PDUs buffered at the LCG reported distinctively from the second total size of the non-urgent PDUs buffered at the same LCG, in which case, because the seventh or the eighth XR-BSR MAC CE can be sent to report only the LCG but no other LCGs of the same UE, the need for explicitly identifying the LCG (e.g., by explicitly indicating the LCG ID of the LCG) in the seventh or the eighth XR-BSR MAC CE is voided. On the other hand, the ninth example XR-BSR MAC CE format, as described above and illustrated in FIG. 15, may be suitable for the case where there are more than one LCGs of the UE, the XR-BSR on which is configured to have the first total size of the urgent PDUs buffered at the LCG reported distinctively from the second total size of the non-urgent PDUs buffered at the same LCG, in which case, a need for explicitly identifying the LCG in the XR-BSR MAC CE may arise. Therefore, whether to use the ninth example XR-BSR MAC CE format or one of the seventh or the eighth example XR-BSR MAC CE formats can be determined by both the UE and the gNB, based on the number of LCGs of the UE, the XR-BSR on the LCGs being configured to have the first total size of the urgent PDUs buffered at a respective LCG reported distinctively from the second total size of the non-urgent PDUs buffered at the respective LCG.

In some embodiments, the UE determines to send a first XR-BSR to the gNB when the first total size of the urgent PDUs buffered at the LCG of the UE becomes non-zero, the first XR-BSR including information indicating the first total size and hence indicating to the gNB that the remaining time of some PDU(s) buffered at the LCG of the UE, with a total data volume equal to the first total size as indicated in the XR-BSR, has become critically low. The information indicating the first total size may be included in the seventh example XR-BSR MAC CE (e.g., as described above and illustrated in FIG. 13), the seventh example XR-BSR MAC CE being sent in the first XR-BSR (or being sent as the first XR-BSR).

In some other embodiments, the UE determines to send the first XR-BSR to the gNB when the UE determines that the radio resource, currently scheduled (e.g., via a CG) for the UE to transmit within a period after sending the first XR-BSR, is insufficient for the UE to deliver its urgent PDUs within associated deadline, the period having a specific duration that is less than or equal to the (reporting) time threshold. For example, when the first total size is greater than the data volume that can be delivered by the radio source currently scheduled for the UE to transmit within the period after sending the first XR-BSR, the UE sends the first XR-BSR to the gNB as soon as possible to allow the gNB to make an adjustment to the existing UL scheduling for the UE (e.g., by supplementing the existing CG-scheduled UL radio source with additionally UL radio resource scheduled by one or more DGs to be sent from the gNB to the UE).

In yet some other embodiments, the UE determines to send a second XR-BSR to the gNB (e.g., when there is an opportunity to send the second XR-BSR as a padding XR-BSR) to provide the gNB with updated buffer status as the buffered data being transmitted, the second XR-BSR including first information indicating the first total size of urgent PDUs buffered at an LCG of the UE and second information indicating the second total size of non-urgent PDUs buffered at the same LCG. In one example, the first information and the second information are included in a same eighth or ninth example XR-BSR MAC CE (e.g., in the First Buffer Size field and the Second Buffer Size field, respectively, as previously described and illustrated in FIGS. 14 and 15), the eight or the ninth example XR-BSR MAC CE being sent in the second XR-BSR (or being sent as the second XR-BSR). In another example, the first information is included in the seventh example XR-BSR MAC CE (e.g., in the First Buffer Size field as previously described and illustrated in FIG. 13), and the second information is included in a Buffer Size field in a legacy BSR MAC CE, as previously described and illustrated in FIGS. 1 and 2, the seventh example XR-BSR MAC CE and the legacy BSR MAC CE being sent in the second XR-BSR (or being sent together as the second XR-BSR).

In yet some other embodiments, if the UE has emptied not only the buffer storing the urgent PDUs of the UE but also all buffers of all the other LCGs of the UE, the UE determines to send a third XR-BSR to the gNB, the third XR-BSR being mostly the same as the second XR-BSR as described above, except that in this situation, the first information in the third XR-BSR further indicates the first total size being zero and the second information in the third XR-BSR also further indicates the second total size being zero, and hence the third XR-BSR indicating to the gNB that the UE has no more data to transmit. In response to receiving, from the UE, the third XR-BSR indicating the UE has no more data to transmit, the gNB may determine to re-schedule any remaining radio resource, currently scheduled for the UE to transmit but would become unused by the UE, for another UE to transmit.

In yet some other embodiments, the UE determines to send a fourth XR-BSR to the gNB when the first total size of the urgent PDUs buffered at the LCG of the UE becomes zero, the fourth XR-BSR including information indicating the first total size being zero and hence indicating to the gNB that the UE has no urgent PDUs (e.g., when the UE has finished the transmission of all PDUs belonging to a current or the oldest data burst buffered for the LCG, in another word, the UE has reached the end of the current or the oldest data burst buffered for the LCG). The information indicating the first total size being zero may be included in the seventh example XR-BSR MAC CE (e.g., as described above and illustrated in FIG. 13), the seventh example XR-BSR MAC CE being sent in the fourth XR-BSR (or being sent as the fourth XR-BSR). In response to receiving, from the UE, the fourth XR-BSR indicating the UE has no urgent PDUs to transmit, the gNB may determine to re-schedule any remaining radio resource, currently scheduled for the UE to transmit but would become unused by the UE, for another UE to transmit. Since the UE may have reached the end of the current or the oldest data burst buffered for the LCG, the gNB may further instruct the UE enter a power saving mode earlier until a time to wake up for transmitted the next data burst.

Sending the XR-BSR by the UE may not always be triggered exactly at the time when the remaining time of the urgent PDUs comes cross the (reporting) time threshold (e.g., when the UE determines to send the XR-BSR as a padding XR-BSR), as described before. In this situation, when the gNB receives the XR-BSR, the actual remaining time of the urgent PDUs may not be accurately reflected by the value of the (reporting) time threshold known to the gNB. Hence, in some embodiments, in addition to the first total size, the UE may further include an explicit indication of the remaining time associated with the urgent PDUs in the XR-BSR sent to the gNB. For example, each of the seventh to the ninth example XR-BSR MAC CE formats illustrated in FIGS. 13-15 and described above may further include in an additional field (e.g., a Remaining Time field not shown in FIGS. 13-15), information carried in the field indicating the remaining time associated with the urgent PDUs, the remaining time being the most updated one (e.g., the one determined right before the XR-BSR is generated and sent). The length (e.g., 8 bits) and the location of the field (e.g., the Remaining Time field) in the seventh to the ninth example XR-BSR MAC CE formats may be specified by the standards. The presence of the field may be further indicated by an additional indication field in the seventh to the ninth example XR-BSR MAC CE formats.

The gNB receives, from the UE, an XR-BSR indicating the first total size of the urgent PDUs, remaining time associated with the urgent PDUs being less than or equal to the (urgency or reporting) time threshold. In some example embodiments, value(s) of the (urgency and reporting) time threshold(s) may have been determined by the gNB (e.g., based on an amount of time that the gNB needs to respond to a critical condition (such as too much urgent data pending a transmission at the UE) revealed by the XR-BSR from the UE), and provided to the UE for the UE to classify PDUs buffered at the UE as urgent or non-urgent (using the urgency time threshold) and to trigger the sending of an XR-BSR (using the reporting time threshold). In some other example embodiments, the value(s) of the (urgency and reporting) time threshold(s) may have been pre-specified (e.g., via standardization), and hence is/are known to both the gNB and the UE. Then, the gNB determines a need for scheduling or adjusting existing scheduling for the UE to transmit. In one example, the gNB determines a third total size of data that the UE may be able to deliver to the gNB within a period upon receiving the XR-BSR using currently scheduled (e.g., a CG-scheduled) radio resource, if there is any, for the UE to transmit within the period, the period having a duration that is less than or equal to the remaining time, if the remaining time is also indicated by the UE in the XR-BSR (e.g., in the Remaining Time field in the XR-BSR as previously described); otherwise, the period having a duration that is less than or equal to the (reporting) time threshold. If there is no currently scheduled radio resource for the UE to transmit within the period, the third total size is determined as zero. If the third total size determined is greater than or equal to the first total size, the gNB may determine that there is no need to schedule additional radio resource for the UE in its current UL traffic cycle, especially if the gNB is unaware of any non-urgent PDUs being buffered at the UE or if the gNB is unable to spare any radio resource for the non-urgent PDUs of the UE at the moment (e.g., when a cell used by the UE and served by the gNB is fully loaded). If the third total size is less than the first total size, the gNB determines that there is a need to additionally schedule a second radio resource for the UE to transmit within the period. For example, the amount of the second radio resource should be sufficient for the UE to deliver data with a size of the first total size subtracted by the third total size. In another example, the gNB determines a total amount of radio resource required for the UE to transmit the urgent PDUs within a period upon receiving the XR-BSR, the period having a duration that is less than or equal to the remaining time, if the remaining time is also indicated by the UE in the XR-BSR; otherwise, the period having a duration that is less than or equal to the (reporting) time threshold. The gNB also determines a first amount of a first radio resource currently scheduled (e.g., using a CG) for the UE to transmit within the period. If there is no radio resource currently scheduled for the UE to transmit within the period, the first amount is determined as zero. In response to the first amount being less than the total amount required, the gNB further schedules (e.g., using one or more DGs) a second radio resource for the UE to transmit within the period, for example, a sum of an amount of the second radio resource and the first amount being greater than or equal to the total amount.

In some example embodiments (such as the second XR-BSR previously described), in addition to the first total size of the urgent PDUs buffered at the LCG of the UE, the XR-BSR sent from the UE may further indicate the second total size of the non-urgent PDUs buffered at the same LCG of the UE and/or additional buffer size(s) of data buffered at other LCG(s) of the UE (e.g., an LCG used for serving a non-XR traffic of the UE). When the UL traffics of other UEs in the same cell used by the UE and served by the gNB are light or expected to be light at least within the period after the gNB receiving the second XR-BSR from the UE (e.g., the lightly loaded condition being indicated by XR-BSRs reported by the other UEs), the gNB may schedule the second radio resource for the UE to transmit within the period to also allow the UE to start to transmit at least some, if not all, of the non-urgent PDUs and PDUs buffered at the other LCGs of the UE, even if the first amount is greater than or equal to the total amount required for transmitting the urgent PDUs of the UE. Then, the gNB sends scheduling information about the second radio resource to the UE.

In some embodiments, the gNB obtains information about the UE capabilities of the UE with regards to performing the classification and the reporting, as previously described. For example, the gNB may obtain the information from the UE when the UE indicates its UE capabilities to the gNB. For another example, the gNB may retrieve the information from a core network node that stored the information previously.

In some embodiments, when the gNB establishes the DRB for conveying data of a QoS flow carrying an XR video traffic from the UE to the gNB, the gNB may have received information about the QoS profiles of the QoS flow that the DRB is configured for. The QoS profiles may include information indicating that the QoS flow supports the transfer of PDU Sets. For example, the information may be an IE referred to as the pduSetSupport IE in the QoS profiles. In this situation, if the UE capabilities of the UE indicate that the UE is capable of performing the classification and the reporting described herein and if the gNB is also capable of responding to the classification and the reporting, the gNB configures the UE to perform the classification and the reporting on the LCH and/or the LCG that is configured for the UE in association with the DRB.

In some embodiments, in a configuration information sent from the gNB to the UE, the gNB may include information indicating that the DRB, the LCH, and/or the LCG being configured for the UE support the transfer of PDU Sets. In some embodiments, in a configuration information sent from the gNB to the UE, the gNB may include information indicating to the UE to perform the classification and the reporting. In some embodiments, in a configuration information sent from the gNB to the UE, the gNB may include information indicating the urgency time threshold to be used in the classification and/or the reporting time threshold to be used in triggering an XR-BSR. Alternatively, the gNB may configure the UE with information about the reporting time threshold and a margin time duration, the urgency time threshold being determined as a sum of the reporting time threshold and the margin time duration. Yet alternatively, the gNB may configure the UE with information about the urgency time threshold and an advance-warning time duration, the reporting time threshold being determined as the urgency time threshold subtracted by the advance-warning time duration. For example, the gNB may determine a value of the margin time duration or a value of the advance-warning time duration based on how wide, in time, the multiple physical uplink shared channel occasions (PUSCH-Os) (within each traffic cycle) in the CG scheduled by the gNB for the UE are spread. For another example, in the case of different traffic streams of multi-modality services being mapped onto the same LCG of the UE, the gNB may determine the value of the margin time duration or the value of the advance-warning time duration based on the time synchronization error (or margin) between the respective starting points of the corresponding traffic cycles of different traffic streams. The indicating of the urgency and/or reporting time threshold(s) may also serve as an implicit indicator indicating to the UE to perform the classification and the reporting. In some embodiments, the urgency and/or reporting time threshold(s) may be indicated as a part of the configuration for the LCG, and hence being applicable only to the LCG. In some embodiments, the urgency and/or reporting time threshold(s) may be indicated as a part of the configuration for the UE, independent of any specific LCGs, and hence being applicable to any LCGs of the UE.

In some embodiments, in a configuration information sent from the gNB to the UE, the gNB may include a first information about a first Buffer Size table to be used by the UE for generating a second information indicating the first total size (for the urgent data volume), which table is also to be used by the gNB for interpreting the second information generated by the UE and reported to the gNB in an XR-BSR (e.g., by using the table in translating the second information into an estimation (due to the finite quantization) of the first total size). In one embodiment, the first information about the first Buffer Size table may include a third information about a minimal buffer size and a maximal buffer size, the first Buffer Size table covering a buffer size range from the minimal buffer size to the maximal buffer size in a linear manner with a specific number of codepoints in between. In another embodiment, the first information about the first Buffer Size table may include a fourth information about a minimal buffer size and a slope of a line, the first Buffer Size table covering a buffer size range starting from the minimal buffer size and thereon with a specific number of codepoints, the buffer sizes associated with which codepoints are computed in a liner manner in accordance with the slope of the line and with the minimal buffer size being a starting point of the line.

In some embodiments, in a configuration information sent from the gNB to the UE, the gNB may include a fifth information indicating a second Buffer Size table to be used by the UE for generating a sixth information indicating the second total size (for the non-urgent data volume), which table is also to be used by the gNB for interpreting the sixth information generated by the UE and reported to the gNB in a BSR (e.g., by using the table in translating the six information into an estimation (also due to finite quantization) of the second total size). For example, the fifth information may be a simple indicator indicating whether the second Buffer Size table is the same as the first Buffer Size table used on the first total size. If the second Buffer Size table is not the first Buffer Size table, the second Buffer Size table is one of the two legacy Buffer Size tables (one of which is illustrated in Table 1) that uses a same number of bits to indicate a buffer size. For another example, the fifth information may be a table ID identifying which table among a plurality of tables is to be used as the second Buffer Size table. The plurality of tables and the corresponding table IDs are to be specified in the standards.

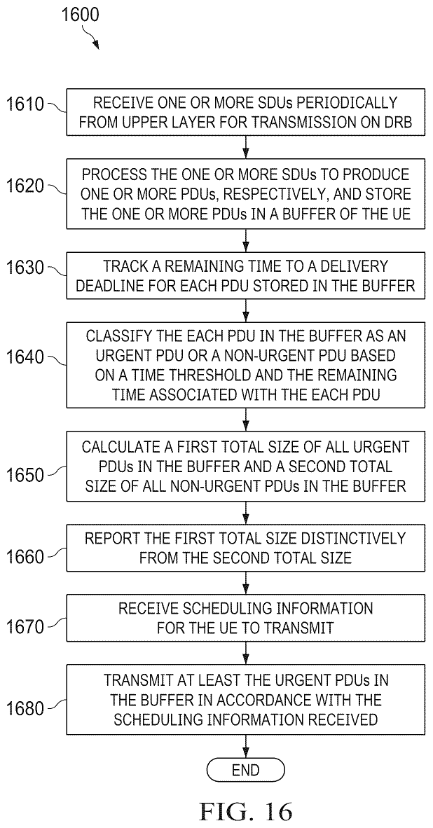

FIG. 16 illustrates a flow diagram of example operation flow 1600 occurring in a UE. Operation flow 1600 may be indicative of operations occurring in a UE, as the UE reports, to a gNB serving the UE, a size of urgent data buffered at an LCG of the UE distinctively from a size of non-urgent data buffered at the same LCG of the UE.

Operation flow 1600 may begin with the UE receiving one or more SDUs periodically from an associated upper layer for transmission on a DRB configured for the UE at the operation 1610. For example, the DRB may be configured between the UE and a gNB serving the UE for transporting a real-time multimedia traffic (such as an XR video traffic) generated by the UE, the DRB being associated with the LCG of the UE. The one or more SDUs may be one or more PDCP SDUs received at a PDCP entity of the UE, the PDCP entity being configured in the UE in associated with the DRB and the LCG of the UE. For example, the one or more SDUs may belong to a same PDU Set together carrying an application data unit (ADU) such as a video frame or a slice of the video frame generated for the XR video service. For another example, the one or more SDUs may belong to a same data burst that includes more than one PDU Sets (e.g., one PDU Set carrying a base layer ADU representing a video frame with a lower resolution and another PDU Set carrying a spatial enhancement layer ADU, together with the base layer ADU, representing the same video frame with a higher resolution). The UE processes the one or more SDUs to produce one or more PDUs, respectively, and store the one or more PDUs in a buffer associated with the LCG of the UE at the operation 1620. For example, processing the one or more SDUs to produce the one or more PDUs may comprise using the PDCP entity of the UE to perform header compression, integrity protection, and ciphering on the one or more PDCP SDUs to produce the one or more PDCP PDUs. The storing may comprise submitting the one or more PDCP PDUs to an underlying RLC entity and storing them (as corresponding RLC SDUs) in a transmission buffer in the RLC entity, the RLC entity being configured in the UE in associated with the DRB and the LCG of the UE.

As time goes by, the UE keeps tracking a remaining time to a delivery deadline for each PDU (including PDCP SDUs still stored in the PDCP entity waiting for the PDCP processing and RLC SDUs already submitted to the RLC entity after the PDCP processing) stored in the respective transmission buffer(s) associated with the LCG at the operation 1630. For example, upon receiving a PDCP SDU at the PDCP entity of the UE from upper layer for transmission, the UE starts a timer referred to as the discardTimer in associated with the PDCP SDU and any PDU produced from it. The discardTimer is initialized to a specific value in accordance with a delay budget, which is the maximal delay allowed in transferring the PDCP SDU to the gNB, and hence the deadline for delivering the PDCP SDU is reached when the discardTimer expires. Before that happens, the remaining value on the discardTimer can be used for determining the remaining time of the PDCP SDU as well any PDU produced from the PDCP SDU. The UE further classifies the each PDU in the respective transmission buffer(s) associated with the LCG as an urgent PDU or a non-urgent PDU based on a (urgency) time threshold associated with the LCG and the remaining time associated with the each PDU at the operation 1640. For example, in addition to the urgency time threshold, a second time threshold (the reporting time threshold) may be indicated to the UE for the LCG of the UE for the UE determining when to trigger an XR-BSR, e.g., indicated to the UE explicitly or as the urgency time threshold subtracted by an advance-warning time duration known to the UE, the reporting time threshold being smaller than the urgency time threshold. For example, the (urgency and/or reporting) time threshold(s) is/are determined by the gNB for the LCG of the UE (e.g., based on an amount of time that the gNB needs to respond to a critical condition (such as too much urgent data pending a transmission at the UE) revealed by the XR-BSR from the UE, or based on a traffic periodicity of a traffic carried on the LCG, in which case, the (urgency and/or reporting) time threshold may be LCG-specific), and provided to the UE using a control plane message such as an RRC Setup or RRC Reconfiguration message sent from the gNB to the UE. For another example, the (urgency and/or reporting) time threshold(s) may be pre-specified (e.g., in standards), and is/are therefore known to both UEs and gNBs in compliance with the standards. The classifying is an on-going process (e.g., as time goes by), such that when the remaining time of a previously non-urgent PDU becomes less than or equal to the (urgency) time threshold, the PDU is re-classified as an urgent PDU.

The UE calculates a first total size of all urgent PDUs in the respective transmission buffer(s) associated with the LCG and a second total size of all non-urgent PDUs in the respective transmission buffer(s) associated with the LCG at the operation 1650. When a need to send an XR-BSR to the gNB is determined, the UE reports information about the first total size distinctively from information about the second total size at the operation 1660. For example, the need to send the XR-BSR may be determined when the first total size of the urgent PDUs buffered at the LCG of the UE becomes non-zero or when the UE determines that the radio resource, currently scheduled (e.g., via a CG) for the UE to transmit within a period after sending the XR-BSR, is insufficient for the UE to deliver its urgent PDUs within associated deadline, the period having a specific duration that is less than or equal to the (reporting) time threshold. For another example, in the XR-BSR sent by the UE to the gNB, the information about the first total size is included in a first MAC CE, while the information about the second total size, if included in the XR-BSR, is included in a second MAC CE, the first MAC CE being an XR-BSR MAC CE and the second MAC CE being one of the legacy BSR MAC CE. For yet another example, in the XR-BSR sent by the UE to the gNB, the information about the first total size is included in a first field in an XR-BSR MAC CE and the information about the second total size is included in a second field in the same XR-BSR MAC CE. The UE may further include an indication of the remaining time associated with the urgent PDUs in the XR-BSR sent to the gNB. For example, information carried in a Remaining Time field in the XR-BSR may indicate the remaining time associated with the urgent PDUs. The remaining time being indicted may be the most updated one (e.g., the one determined right before the XR-BSR is generated and sent).

The UE receives scheduling information from the gNB for the UE to transmit at the operation 1670. The scheduling information may include information about additional radio resource for the UE to use in transmitting buffered data. The scheduling information may be received via one or more DGs on the PDCCH. Then, the UE transmits at least the urgent PDUs in the buffer using the CG-scheduled radio resource for the UE, if there is any, and the additional radio resource scheduled by the scheduling information received (e.g., via the one or more DGs), at the operation 1680. Then, operation flow 1600 may end.

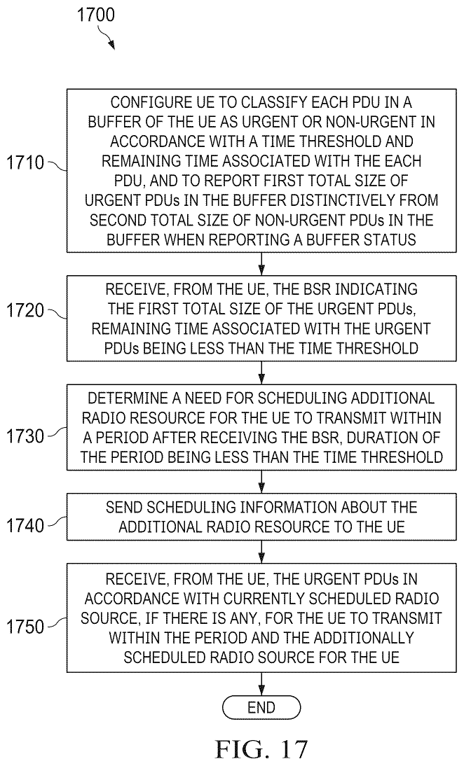

FIG. 17 illustrates a flow diagram of example operation flow 1700 occurring in a gNB. Operation flow 1700 may be indicative of operations occurring in a gNB, as the gNB configures a UE served by the gNB to report its buffer status on an LCG of the UE using an XR-BSR, receives the XR-BSR from the UE, and based thereon, schedules or adjusts existing scheduling for the UE to transmit to the gNB. For example, the LCG is configured in associated with a DRB of the UE, the DRB being configured for carrying a real-time multimedia traffic (such as an XR video traffic) generated by the UE.

Operation flow 1700 may begin with the gNB configuring a UE to classify each PDU in respective transmission buffer(s) associated with the LCG of the UE as urgent or non-urgent in accordance with a (urgency) time threshold and a remaining time associated with the each PDU, and to report a first total size of all urgent PDUs in the respective transmission buffer(s) (i.e., buffered for the LCG) distinctively from a second total size of all non-urgent PDUs in the same respective transmission buffer(s) (i.e., buffered for the same LCG) when reporting a buffer status to the gNB at the operation 1710. The gNB may additionally indicate to the UE a second time threshold (the reporting time threshold) for the LCG of the UE for the UE determining when to trigger an XR-BSR, e.g., the reporting time threshold being indicated to the UE explicitly or as the urgency time threshold subtracted by an advance-warning time duration known to the UE, the reporting time threshold being smaller than the urgency time threshold. The gNB may have obtained information about the UE capabilities with regard to performing the classification and the reporting before the gNB configures the UE to do so. The gNB may have determined a value for the (urgency and/or reporting) time (period) threshold(s) based on an amount of time that the gNB needs to schedule UL radio resource for a UE in response to an XR-BSR received from UE or based on a traffic periodicity of a traffic carried on the LCG. The (urgency and/or reporting) time threshold(s) may be determined and configured as being LCG-specific. The gNB may indicate the (urgency and reporting) time threshold(s) to the UE when configuring the UE (e.g., by including information indicating the time threshold(s) in an RRC Setup or RRC Reconfiguration message sent to the UE). The gNB receives, from the UE, the XR-BSR indicating the first total size of the urgent PDUs buffered on the LCG, remaining time associated with the urgent PDUs being less than the (reporting) time threshold, at the operation 1720.

Then, the gNB determines a need for scheduling additional radio resource for the UE to transmit within a period after receiving the XR-BSR, duration of the period being less than or equal to the (reporting) time threshold, at the operation 1730. For example, the gNB may determine a total amount of radio resource required for the UE to transmit the urgent PDUs within a period after receiving the XR-BSR, the period having a specific duration that is less than or equal to the remaining time, if the remaining time is also indicated by the UE in the XR-BSR (e.g., in the Remaining Time field in the XR-BSR as described above); otherwise, the period having a duration that is less than or equal to the (reporting) time threshold. The gNB may also determine a first amount of a first radio resource currently scheduled (e.g., using a CG) for the UE to transmit within the period. And, in response to the first amount being less than the total amount required, the gNB may further schedule (e.g., using one or more DGs) a second radio resource for the UE to transmit within the period, for example, a sum of an amount of the second radio resource and the first amount being greater than or equal to the total amount. For another example, the gNB may determine a third total size of data that the UE may be able to deliver to the gNB within a period after receiving the XR-BSR using currently scheduled (e.g., a CG-scheduled) radio resource, if there is any, for the UE to transmit within the period, the period having a specific duration that is less than or equal to the remaining time, if the remaining time is also indicated by the UE in the XR-BSR (e.g., in the Remaining Time field in the XR-BSR as previously described); otherwise, the period having a duration that is less than or equal to the (reporting) time threshold. If the third total size is less than the first total size, the gNB determines that there is a need to additionally schedule a second radio resource for the UE to transmit within the period.

Then, the gNB sends scheduling information about the additionally scheduled radio resource to the UE at the operation 1740. For example, the scheduling information is sent to the UE via one or more DGs sent on the PDCCH. The gNB receives, from the UE, the urgent PDUs in accordance with currently scheduled radio source, if there is any, for the UE to transmit within the period and the additionally scheduled radio source for the UE at the operation 1750. Then, the operation flow 1700 may end.

This disclosure provides a procedure for the UE to classify PDUs stored in a buffer of the UE as urgent or non-urgent PDUs based on associated remaining time and a (urgency) time threshold.

This disclosure provides a new buffer status report procedure (referred to as the XR-BSR) and new MAC CE formats (referred to as the XR-BSR MAC CEs) for the UE to report a first total size of urgent PDUs buffered at an LCG of the UE distinctively from a second total size of non-urgent PDUs buffered at the same LCG when reporting a buffer status to the gNB, the reporting further indicating remaining time associated with the first total size being less than or equal to the (reporting) time threshold.

This disclosure provides a procedure for the gNB to determine whether currently scheduled radio resource for the UE being sufficient for the UE to deliver the urgent PDUs to the gNB within a deadline, and in response to determining the currently scheduled radio resource being insufficient, to schedule additional radio resource for the UE to allow the UE to deliver the urgent PDUs to the gNB within the deadline.

This disclosure provides a signaling mechanism for the UE to indicate its capability of performing the classification and the reporting to the gNB and a signaling mechanism for the gNB to configure the UE to perform the classification and the reporting.

Technical solutions of this disclosure simplify gNB implementations by not requiring a gNB implementation to keep tracking the remaining time of each data burst of each LCG of each UE served by the gNB. Instead, the gNB reacts only to critical condition(s) such as the total size of urgent PDUs reported by the UE being greater than what the radio source in an existing UL scheduling for the UE can handle.

Technical solutions of this disclosure reduce signaling overhead when reporting a buffer status by not sending the remaining time information explicitly, by allowing the UE to report only the total size of urgent PDUs buffered at the UE, and by allowing the UE to send the XR-BSR only when a critical condition arises (e.g., when the UE determines that the radio resource in an existing scheduling for the UE is insufficient for the UE to deliver its urgent PDUs within associated deadline).

The embodiment feature of the new reporting mechanism and the various example MAC CEs for the new reporting, compared to the legacy BSR and legacy BSR MAC CEs, is that the new reporting mechanism indicates a delay status associated with the first total size being reported, the first total size being associated with either the urgent data or the oldest data burst to be transmitted. For example, the delay status may be a remaining time duration explicitly indicated in the new report and associated with the urgent data or the oldest data burst to be transmitted. For another example, the delay status may be an implicit indication that the remaining time duration associated with the urgent data or the oldest data burst to be transmitted is below a specific (reporting) time threshold by merely the fact that the new example XR-BSR MAC CE is used for sending the report, instead of the legacy BSR MAC CEs. Although this disclosure has used the terms “XR-BSR” and “example XR-BSR MAC CE” throughout previous description using XR applications as an example, the new reporting mechanism and the various example MAC CEs for the new reporting described in this disclosure can be applied to other non-XR applications. Further, the new reporting mechanism and the various example MAC CEs for the new reporting described in this disclosure may be referred to by other names, e.g., referred to as the “delay status report (DSR)” and “example DSR MAC CE.”

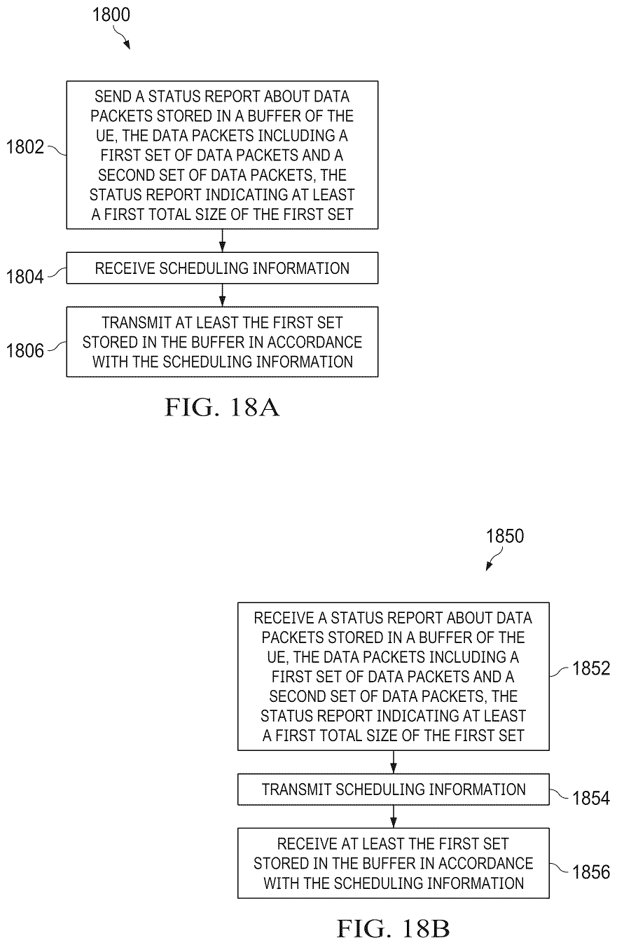

FIG. 18A shows a flow chart of a method 1800 performed by a UE, according to some embodiments. The UE may include computer-readable code or instructions executing on one or more processors of the UE. Coding of the software for carrying out or performing the method 1800 is well within the scope of a person of ordinary skill in the art having regard to the present disclosure. The method 1800 may include additional or fewer operations than those shown and described and may be carried out or performed in a different order. Computer-readable code or instructions of the software executable by the one or more processors may be stored on a non-transitory computer-readable medium, such as for example, the memory of the UE.

The method 1800 starts at the operation 1802, where the UE sends, to a base station, a status report about data packets stored in a buffer of the UE. The data packets are associated with a logical channel group (LCG). The data packets include a first set of data packets and a second set of data packets. The status report indicates at least a first total size of the first set. At the operation 1804, the UE receives, from the base station, scheduling information. At the operation 1806, the UE transmits, to the base station, at least the first set stored in the buffer in accordance with the scheduling information.

In some embodiments, the UE may classify each data packet of the data packets as urgent or non-urgent based on comparing a first time threshold with a corresponding remaining time of the each data packet. In some embodiments, the UE may classify the each data packet by classifying a first packet as urgent based on a first remaining time of the first packet being less than or equal to the first time threshold and classifying a second packet as non-urgent based on a second remaining time of the second packet being greater than the first time threshold. In some embodiments, the UE may classify the each data packet by classifying the first packet as urgent based on the first remaining time of the first packet being less than the first time threshold and classifying the second packet as non-urgent based on the second remaining time of the second packet being greater than or equal to the first time threshold.

In some embodiments, the first set may include all urgent data packets of the data packets. The second set may include all non-urgent data packets of the data packets.

In some embodiments, the first set may include all urgent data packets of the data packets. The first set may be a subset of the second set. The second set may include all of the data packets.

In some embodiments, the first time threshold may be LCG-specific.

In some embodiments, the status report may be sent in one or more media access control (MAC) control elements (CEs). In some embodiments, the one or more MAC CEs may include a first MAC CE. The first MAC CE may include a first buffer size field indicating the first total size. In some embodiments, the status report may further indicate a second total size of the second set. In some embodiments, the first MAC CE may further include a second buffer size field indicating the second total size.

In some embodiments, the UE may send, to the base station, capability information indicating capabilities of the UE with regards to performing the classification and the reporting. The UE may receive, from the base station, configuration information for the UE to classify the each data packet. In some embodiments, the configuration information may indicate the first time threshold.

In some embodiments, the one or more MAC CEs may further include a second MAC CE. The second MAC CE may be one of legacy buffer status report (BSR) MAC CEs and include a second buffer size field indicating the second total size. In some embodiments, the legacy BSR MAC CEs may include at least one of a short BSR MAC CE, a short truncated BSR MAC CE, a long BSR MAC CE, or a long truncated BSR MAC CE.

In some embodiments, the first MAC CE may include an LCG identifier (ID) field indicating the LCG.

In some embodiments, the first MAC CE may further indicate that duration of a third remaining time to a delivery deadline associated with the first set is less than the first time threshold.

In some embodiments, the first MAC CE further include a remaining time duration field indicating the duration of the third remaining time.

In some embodiments, the scheduling information may indicate one or more radio resources. The UE may transmit, to the base station, the urgent data packets on the one or more radio resources. In some embodiments, the one or more radio resources may supplement a currently scheduled radio resource for the UE to transmit. In some embodiments, the UE may transmit, to the base station, the urgent data packets on the one or more radio resources and the currently scheduled radio resource.

In some embodiments, the sending of the status report may be in response to a second time threshold being greater than a corresponding remaining time of one data packet among the first set. In some embodiments, a value of the second time threshold may be indicated by the base station to the UE. In some embodiments, the value of the second time threshold may be determined as a value of the first time threshold subtracted by a value of a first time duration. In some embodiments, the value of the first time duration may be determined by the base station and indicated to the UE.

In some embodiments, a value of the first time threshold may be determined as a sum of the value of the second time threshold and a value of a second time duration. In some embodiments, the value of the second time duration may be determined by the base station and indicated to the UE.

In some embodiments, the first set may be a first data burst of data bursts received in a logical channel (LCH) of the LCG. The second set may be a second data burst of the data bursts. Each data burst of the data bursts may correspond to a respective delivery deadline. In some embodiments, the status report may further indicate duration of a fourth remaining time to a delivery deadline of the first data burst. In some embodiments, the UE may send, to the base station, a UE assistance information (UAI) indicating a nominal data burst arrival time offset at the LCH. In some embodiments, the UE may receive, from the base station, configuration information for reporting information about the data bursts. The UE may configure a MAC entity of the UE to send the status report in accordance with the configuration information.

FIG. 18B shows a flow chart of a method 1850 performed by a base station, according to some embodiments. The base station may include computer-readable code or instructions executing on one or more processors of the base station. Coding of the software for carrying out or performing the method 1850 is well within the scope of a person of ordinary skill in the art having regard to the present disclosure. The method 1850 may include additional or fewer operations than those shown and described and may be carried out or performed in a different order. Computer-readable code or instructions of the software executable by the one or more processors may be stored on a non-transitory computer-readable medium, such as for example, the memory of the base station.

The method 1850 starts at the operation 1852, where the base station receives, from a UE, a status report about data packets stored in a buffer of the UE. The data packets are associated with a logical channel group (LCG). The data packets include a first set of data packets and a second set of data packets. The status report indicates at least a first total size of the first set. At the operation 1854, the base station transmits, to the UE, scheduling information. At the operation 1856, the base station receives, from the UE, at least the first set stored in the buffer in accordance with the scheduling information.

In some embodiments, the base station may obtain information about a first remaining time duration to a first delivery deadline of the first set and a second remaining time duration to a second delivery deadline of the second set. In some embodiments, the first remaining time duration may be obtained from the status report received from the UE. The second remaining time duration may be derived based on the first remaining time duration. In some embodiments, the base station may receive, from the UE, information about a nominal data burst arrival time offset of the UE. The first remaining time duration and the second remaining time duration may be obtained based on the information about the nominal data burst arrival time offset and a time that the status report is received by the base station.

In some embodiments, the base station may send, to the UE, configuration information prior to the receiving of the status report. The configuration information may indicate to the UE to classify each data packet of the data packets as urgent or non-urgent in accordance with a corresponding remaining time associated with the each data packet. In some embodiments, the configuration information may indicate a first time threshold to the UE. The each data packet may be classified by the UE as urgent or non-urgent in accordance with a result of a comparison between the first time threshold and the corresponding remaining time associated with the each data packet. In some embodiments, the configuration information may further indicate a second time threshold to the UE. The receiving of the status report may indicate that the second time threshold is greater than a corresponding remaining time of at least one data packet among the first set. In some embodiments, a value of the second time threshold may be determined as a value of the first time threshold subtracted by a value of a first time duration. In some embodiments, the value of the first time duration may be determined by the base station and indicated to the UE in the configuration information. In some embodiments, a value of the first time threshold may be determined as a sum of a value of the second time threshold and a value of a second time duration. In some embodiments, the value of the second time duration may be determined by the base station and indicated to the UE in the configuration information.

In some embodiments, the first set may include all urgent data packets of the data packets. The second set may include all non-urgent data packets of the data packets.

In some embodiments, the first set may include all urgent data packets of the data packets. The first set may be a subset of the second set. The second set may include all of the data packets.

In some embodiments, the status report may be received in one or more media access control (MAC) control elements (CEs). In some embodiments, the one or more MAC CEs may include a first MAC CE. The first MAC CE may include a first buffer size field indicating the first total size. In some embodiments, the status report may further indicate a second total size of the second set. In some embodiments, the first MAC CE may further include a second buffer size field indicating the second total size. In some embodiments, the one or more MAC CEs may further include a second MAC CE. The second MAC CE may be one of legacy buffer status report (BSR) MAC CEs and include a second buffer size field indicating the second total size. In some embodiments, the legacy BSR MAC CEs may include at least one of a short BSR MAC CE, a short truncated BSR MAC CE, a long BSR MAC CE, or a long truncated BSR MAC CE.

In some embodiments, the first MAC CE may include an LCG identifier (ID) field indicating the LCG.

In some embodiments, the first MAC CE may further indicate that duration of a third remaining time to a delivery deadline associated with the first set is less than the first time threshold.

In some embodiments, the first MAC CE may further include a remaining time duration field indicating the duration of the third remaining time.

In some embodiments, the base station may obtain a first estimation of the first total size using a first information indicating the first total size in the status report and a first buffer size table. The base station may determine a need for scheduling an additional radio resource for the UE using the first estimation of the first total size. In some embodiments, buffer size levels in the first buffer size table may be computed as a linear function of buffer size indices in the first buffer size table. The first estimation of the first total size may be obtained as a buffer size level in the first buffer size table corresponding to a buffer size index in the first buffer size table. The buffer size index may be included in the status report for indicating the first total size.

In some embodiments, the configuration information may further indicate a second buffer size table to be used by the UE in determining the second total size. The base station may obtain a second estimation of the second total size using second information indicating the second total size in the status report and the second buffer size table. In some embodiments, the second buffer size table may be one of the first buffer size table or a legacy buffer size table. Buffer size levels in the legacy buffer size table may be computed as an exponential function of buffer size indices in the legacy buffer size table.

In some embodiments, the scheduling information may indicate one or more radio resources. The base station may receive, from the UE, the urgent data packets on the one or more radio resources. In some embodiments, the one or more radio resources may supplement a currently scheduled radio resource for the UE to transmit. In some embodiments, the base station may receive, from the UE, the urgent data packets on the one or more radio resources and the currently scheduled radio resource.

In some embodiments, the first set may be a first data burst of data bursts received in a logical channel (LCH) of the LCG. The second set may be a second data burst of the data bursts. Each data burst of the data bursts may correspond to a respective delivery deadline. In some embodiments, the status report may further indicate duration of a fourth remaining time to a delivery deadline of the first data burst.

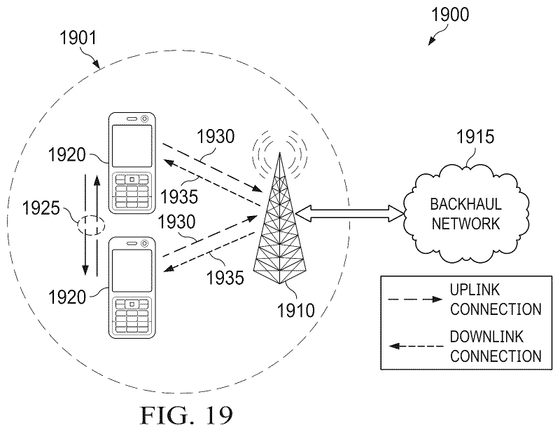

FIG. 19 illustrates an example communications system 1900. Communications system 1900 includes an access node 1910 serving user equipments (UEs) with a coverage area 1901, such as UEs 1920. In a first operating mode, communications to and from a UE passes through access node 1910 with coverage area 1901. The access node 1910 is connected to a backhaul network 1915 for connecting to the internet, operations and management, and so forth. In a second operating mode, communications to and from a UE do not pass through access node 1910, however, access node 1910 typically allocates resources used by the UE to communicate when specific conditions are met. Communications between a pair of UEs 1920 can use a sidelink connection (shown as two separate one-way connections 1925). In FIG. 19, the sideline communication is occurring between two UEs operating inside of coverage area 1901. However, sidelink communications, in general, can occur when UEs 1920 are both outside coverage area 1901, both inside coverage area 1901, or one inside and the other outside coverage area 1901. Communication between a UE and access node pair occur over uni-directional communication links, where the communication links between the UE and the access node are referred to as uplinks 1930, and the communication links between the access node and UE is referred to as downlinks 1935.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

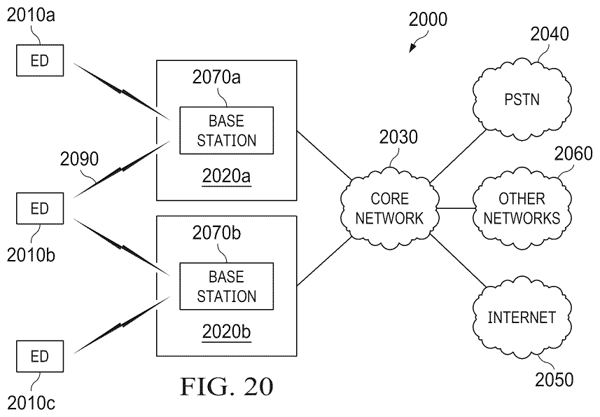

FIG. 20 illustrates an example communication system 2000. In general, the system 2000 enables multiple wireless or wired users to transmit and receive data and other content. The system 2000 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 2000 includes electronic devices (ED) 2010a-2010c, radio access networks (RANs) 2020a-2020b, a core network 2030, a public switched telephone network (PSTN) 2040, the Internet 2050, and other networks 2060. While certain numbers of these components or elements are shown in FIG. 20, any number of these components or elements may be included in the system 2000.

The EDs 2010a-2010c are configured to operate or communicate in the system 2000. For example, the EDs 2010a-2010c are configured to transmit or receive via wireless or wired communication channels. Each ED 2010a-2010c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 2020a-2020b here include base stations 2070a-2070b, respectively. Each base station 2070a-2070b is configured to wirelessly interface with one or more of the EDs 2010a-2010c to enable access to the core network 2030, the PSTN 2040, the Internet 2050, or the other networks 2060. For example, the base stations 2070a-2070b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 2010a-2010c are configured to interface and communicate with the Internet 2050 and may access the core network 2030, the PSTN 2040, or the other networks 2060.

In the embodiment shown in FIG. 20, the base station 2070a forms part of the RAN 2020a, which may include other base stations, elements, or devices. Also, the base station 2070b forms part of the RAN 2020b, which may include other base stations, elements, or devices. Each base station 2070a-2070b operates to transmit or receive wireless signals within a particular geographic region or area, sometimes referred to as a “cell.” In some embodiments, multiple-input multiple-output (MIMO) technology may be employed having multiple transceivers for each cell.

The base stations 2070a-2070b communicate with one or more of the EDs 2010a-2010c over one or more air interfaces 2090 using wireless communication links. The air interfaces 2090 may utilize any suitable radio access technology.

It is contemplated that the system 2000 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 2020a-2020b are in communication with the core network 2030 to provide the EDs 2010a-2010c with voice, data, application, Voice over Internet Protocol (VOIP), or other services. Understandably, the RANs 2020a-2020b or the core network 2030 may be in direct or indirect communication with one or more other RANs (not shown). The core network 2030 may also serve as a gateway access for other networks (such as the PSTN 2040, the Internet 2050, and the other networks 2060). In addition, some or all of the EDs 2010a-2010c may include functionality for communicating with different wireless networks over different wireless links using different wireless technologies or protocols. Instead of wireless communication (or in addition thereto), the EDs may communicate via wired communication channels to a service provider or switch (not shown), and to the Internet 2050.

Although FIG. 20 illustrates one example of a communication system, various changes may be made to FIG. 20. For example, the communication system 2000 could include any number of EDs, base stations, networks, or other components in any suitable configuration.

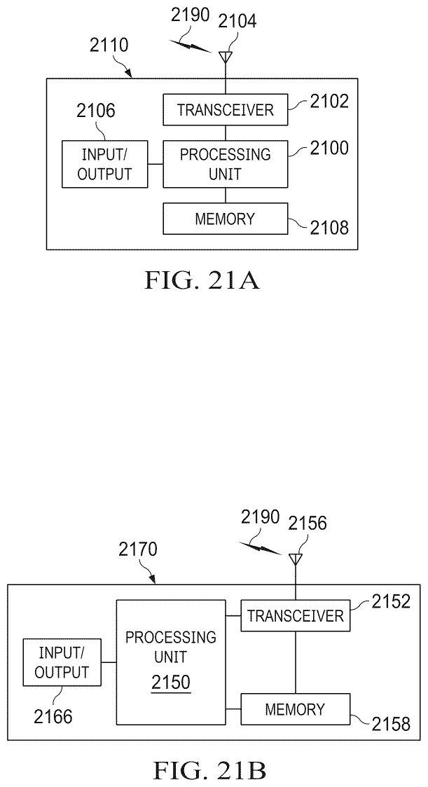

FIGS. 21A and 21B illustrate example devices that may implement the methods and teachings according to this disclosure. In particular, FIG. 21A illustrates an example ED 2110, and FIG. 21B illustrates an example base station 2170. These components could be used in the system 2000 or in any other suitable system.

As shown in FIG. 21A, the ED 2110 includes at least one processing unit 2100. The processing unit 2100 implements various processing operations of the ED 2110. For example, the processing unit 2100 could perform signal coding, data processing, power control, input/output processing, or any other functionality enabling the ED 2110 to operate in the system 2000. The processing unit 2100 also supports the methods and teachings described in more detail above. Each processing unit 2100 includes any suitable processing or computing device configured to perform one or more operations. Each processing unit 2100 could, for example, include a microprocessor, microcontroller, digital signal processor, field programmable gate array, or application specific integrated circuit.

The ED 2110 also includes at least one transceiver 2102. The transceiver 2102 is configured to modulate data or other content for transmission by at least one antenna or NIC (Network Interface Controller) 2104. The transceiver 2102 is also configured to demodulate data or other content received by the at least one antenna 2104. Each transceiver 2102 includes any suitable structure for generating signals for wireless or wired transmission or processing signals received wirelessly or by wire. Each antenna 2104 includes any suitable structure for transmitting or receiving wireless or wired signals. One or multiple transceivers 2102 could be used in the ED 2110, and one or multiple antennas 2104 could be used in the ED 2110. Although shown as a single functional unit, a transceiver 2102 could also be implemented using at least one transmitter and at least one separate receiver.

The ED 2110 further includes one or more input/output devices 2106 or interfaces (such as a wired interface to the Internet 2050). The input/output devices 2106 facilitate interaction with a user or other devices (network communications) in the network. Each input/output device 2106 includes any suitable structure for providing information to or receiving information from a user, such as a speaker, microphone, keypad, keyboard, display, or touch screen, including network interface communications.

In addition, the ED 2110 includes at least one memory 2108. The memory 2108 stores instructions and data used, generated, or collected by the ED 2110. For example, the memory 2108 could store software or firmware instructions executed by the processing unit(s) 2100 and data used to reduce or eliminate interference in incoming signals. Each memory 2108 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 21B, the base station 2170 includes at least one processing unit 2150, at least one transceiver 2152, which includes functionality for a transmitter and a receiver, one or more antennas 2156, at least one memory 2158, and one or more input/output devices or interfaces 2166. A scheduler, which would be understood by one skilled in the art, is coupled to the processing unit 2150. The scheduler could be included within or operated separately from the base station 2170. The processing unit 2150 implements various processing operations of the base station 2170, such as signal coding, data processing, power control, input/output processing, or any other functionality. The processing unit 2150 can also support the methods and teachings described in more detail above. Each processing unit 2150 includes any suitable processing or computing device configured to perform one or more operations. Each processing unit 2150 could, for example, include a microprocessor, microcontroller, digital signal processor, field programmable gate array, or application specific integrated circuit.

Each transceiver 2152 includes any suitable structure for generating signals for wireless or wired transmission to one or more EDs or other devices. Each transceiver 2152 further includes any suitable structure for processing signals received wirelessly or by wire from one or more EDs or other devices. Although shown combined as a transceiver 2152, a transmitter and a receiver could be separate components. Each antenna 2156 includes any suitable structure for transmitting or receiving wireless or wired signals. While a common antenna 2156 is shown here as being coupled to the transceiver 2152, one or more antennas 2156 could be coupled to the transceiver(s) 2152, allowing separate antennas 2156 to be coupled to the transmitter and the receiver if equipped as separate components. Each memory 2158 includes any suitable volatile or non-volatile storage and retrieval device(s). Each input/output device 2166 facilitates interaction with a user or other devices (network communications) in the network. Each input/output device 2166 includes any suitable structure for providing information to or receiving/providing information from a user, including network interface communications.

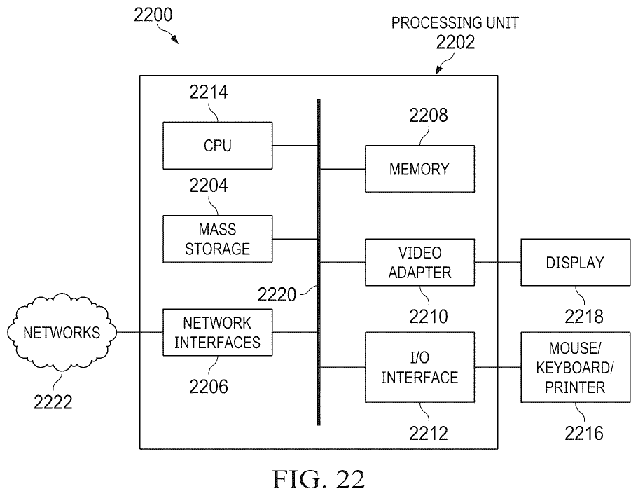

FIG. 22 is a block diagram of a computing system 2200 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2200 includes a processing unit 2202. The processing unit includes a central processing unit (CPU) 2214, memory 2208, and may further include a mass storage device 2204, a video adapter 2210, and an I/O interface 2212 connected to a bus 2220.

The bus 2220 may be one or more of any type of several bus architectures including a memory bus or memory controller, a peripheral bus, or a video bus. The CPU 2214 may comprise any type of electronic data processor. The memory 2208 may comprise any type of non-transitory system memory such as static random access memory (SRAM), dynamic random access memory (DRAM), synchronous DRAM (SDRAM), read-only memory (ROM), or a combination thereof. In an embodiment, the memory 2208 may include ROM for use at boot-up, and DRAM for program and data storage for use while executing programs.

The mass storage 2204 may comprise any type of non-transitory storage device configured to store data, programs, and other information and to make the data, programs, and other information accessible via the bus 2220. The mass storage 2204 may comprise, for example, one or more of a solid state drive, hard disk drive, a magnetic disk drive, or an optical disk drive.

The video adapter 2210 and the I/O interface 2212 provide interfaces to couple external input and output devices to the processing unit 2202. As illustrated, examples of input and output devices include a display 2218 coupled to the video adapter 2210 and a mouse, keyboard, or printer 2216 coupled to the I/O interface 2212. Other devices may be coupled to the processing unit 2202, and additional or fewer interface cards may be utilized. For example, a serial interface such as Universal Serial Bus (USB) (not shown) may be used to provide an interface for an external device.

The processing unit 2202 also includes one or more network interfaces 2206, which may comprise wired links, such as an Ethernet cable, or wireless links to access nodes or different networks. The network interfaces 2206 allow the processing unit 2202 to communicate with remote units via the networks. For example, the network interfaces 2206 may provide wireless communication via one or more transmitters/transmit antennas and one or more receivers/receive antennas. In an embodiment, the processing unit 2202 is coupled to a local-area network 2222 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method, comprising:
sending, by a user equipment (UE) to a base station, a status report about data packets stored in a buffer of the UE, the data packets associated with a logical channel group (LCG), the data packets including a first set of data packets and a second set of data packets, the status report indicating at least a first total size of the first set of data packets;
receiving, by the UE from the base station, scheduling information; and
transmitting, by the UE to the base station, at least the first set of data packets stored in the buffer in accordance with the scheduling information.

2. The method of claim 1, further comprising:
classifying, by the UE, each data packet of the data packets as urgent or non-urgent based on comparing a first time threshold with a corresponding remaining time until a respective delivery deadline of the each data packet.

3. The method of claim 2,
wherein the classifying the each data packet comprises:
classifying, by the UE, a first packet as urgent based on a first remaining time until a first delivery deadline of the first packet being less than or equal to the first time threshold; and
classifying, by the UE, a second packet as non-urgent based on a second remaining time until a second delivery deadline of the second packet being greater than the first time threshold,
or
wherein the classifying the each data packet comprises:
classifying, by the UE, the first packet as urgent based on the first remaining time until the first delivery deadline of the first packet being less than the first time threshold; and
classifying, by the UE, the second packet as non-urgent based on the second remaining time until the second delivery deadline of the second packet being greater than or equal to the first time threshold.

4. The method of claim 2, the first set of data packets including all urgent data packets of the data packets, the second set of data packets including all non-urgent data packets of the data packets.

5. The method of claim 2, the first time threshold being LCG-specific.

6. The method of claim 1, the status report being sent in one or more media access control (MAC) control elements (CEs), wherein the one or more MAC CEs include a first MAC CE, the first MAC CE including a first buffer size field indicating the first total size.

7. The method of claim 6, the status report further indicating a second total size of the second set of data packets, the first MAC CE further including a second buffer size field indicating the second total size.

8. The method of claim 7, further comprising:
sending, by the UE to the base station, capability information indicating a capability of the UE with regards to performing classification and reporting; and
receiving, by the UE from the base station, configuration information for the UE to classify the each data packet, the configuration information indicating the first time threshold.

9. The method of claim 6, the first MAC CE including an LCG identifier (ID) field indicating the LCG.

10. The method of claim 6, the first MAC CE further including a remaining time duration field indicating a remaining time until a delivery deadline of the first set of data packets.

11. A method, comprising:
receiving, by a base station from a user equipment (UE), a status report about data packets stored in a buffer of the UE, the data packets associated with a logical channel group (LCG), the data packets including a first set of data packets and a second set of data packets, the status report indicating at least a first total size of the first set of data packets;
transmitting, by the base station to the UE, scheduling information; and
receiving, by the base station from the UE, at least the first set of data packets stored in the buffer of the UE in accordance with the scheduling information.

12. The method of claim 11, further comprising:
obtaining, by the base station, information about a first remaining time until a first delivery deadline of the first set of data packets and a second remaining time until a second delivery deadline of the second set of data packets.

13. The method of claim 11, further comprising:
sending, by the base station to the UE, configuration information prior to the receiving of the status report, the configuration information indicating to the UE to classify each data packet of the data packets as urgent or non-urgent in accordance with a corresponding remaining time associated with the each data packet.

14. The method of claim 13, the configuration information indicating a first time threshold to the UE, the each data packet being classified by the UE as urgent or non-urgent in accordance with a result of a comparison between the first time threshold and the corresponding remaining time associated with the each data packet.

15. The method of claim 11, the first set of data packets including all urgent data packets of the data packets, the second set of data packets including all non-urgent data packets of the data packets.

16. The method of claim 11, the status report being received in one or more media access control (MAC) control elements (CEs), wherein the one or more MAC CEs include a first MAC CE, the first MAC CE including a first buffer size field indicating the first total size.

17. The method of claim 16, the status report further indicating a second total size of the second set of data packets, the first MAC CE further including a second buffer size field indicating the second total size.

18. The method of claim 16, the first MAC CE further including a remaining time duration field indicating a remaining time until a delivery deadline of the first set of data packets.

19. An apparatus, comprising:
at least one processor; and
a non-transitory memory storing program instructions that, when executed by the at least one processor, cause the apparatus to perform operations including:
sending, to a base station, a status report about data packets stored in a buffer of the apparatus, the data packets associated with a logical channel group (LCG), the data packets including a first set of data packets and a second set of data packets, the status report indicating at least a first total size of the first set of data packets;
receiving, from the base station, scheduling information; and
transmitting, to the base station, at least the first set of data packets stored in the buffer in accordance with the scheduling information.

20. An apparatus, comprising:
at least one processor; and
a non-transitory memory storing program instructions that, when executed by the at least one processor, cause the apparatus to perform operations including:
receiving, from a user equipment (UE), a status report about data packets stored in a buffer of the UE, the data packets associated with a logical channel group (LCG), the data packets including a first set of data packets and a second set of data packets, the status report indicating at least a first total size of the first set of data packets;
transmitting, to the UE, scheduling information; and
receiving, from the UE, at least the first set of data packets in accordance with the scheduling information.
